(19) United States
(12) Patent Application Publication
(10) Pub. No.: US 2026/0322559 A1
(43) Pub. Date: Oct. 15, 2026

(54) SRS HOPPING SCHEME IN WIRELESS NETWORK

(71) Applicant: SAMSUNG ELECTRONICS CO., LTD., Suwon-si, Gyeonggi-do (KR)

(72) Inventors: Karthik MURALIDHAR, Bangalore (IN); Youngrok JANG, Suwon-si (KR); Dattaraj Dileep Raut MULGAONKAR, Bangalore (IN); Diwakar SHARMA, Bangalore (IN); Santanu MONDAL, Bangalore (IN)

(21) Appl. No.: 19/483,948

(22) PCT Filed: May 10, 2024
(86) PCT No.: PCT/KR2024/006391

§ 371 Date: Nov. 12, 2025

(30) Foreign Application Priority Data
May 12, 2023 (IN) 202341033513
Aug. 2, 2023 (IN) 202341051947
Aug. 11, 2023 (IN) 202341053966
Apr. 26, 2024 (IN) 202341033513

(51) Int. Cl. H04L 5/00

(52) U.S. Cl. CPC H04L 5/0051

(57) ABSTRACT

The disclosure relates to a 5G or 6G communication system for supporting a higher data transmission rate. The disclosure provides SRS hopping schemes in a wireless network, wherein comb and/or cyclic shift hopping can be used in intra-slot or inter-slot scenarios for reducing/randomizing interference.

Embodiments disclosed herein relate to wireless communication networks, and more particularly to Sounding Reference Signal (SRS) hopping schemes in the wireless communication networks.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

One of the items being discussed in SRS for Release-18 is enhancements for SRS in 8TX and Time Division Duplex (TDD) Coherent Joint Transmission (TDD-CJT) operation. In the TDD-CJT operation, as it is in the context of multiple transmission and reception point (mTRP), reduction of interference is needed.

### DISCLOSURE OF INVENTION

### Technical Problem

The principal object of the embodiments herein is to disclose SRS hopping schemes in a wireless network, wherein comb and/or cyclic shift hopping can be used in intra-slot or inter-slot scenarios for reducing/randomizing interference, which can be determined by UE capability and configured by RRC messages, and the hopping can be intra-slot (within a slot) or across slots (inter-slot) or both.

Another object of the embodiments herein is to disclose SRS hopping schemes, wherein the hopping takes care of legacy UEs in that certain comb/CS values can be skipped, and the skipped values or the region where comb/CS hopping is done can be configured by a Medium Access Control Control-Element (MAC-CE), Downlink Control Information (DCI) or Radio Resource Control (RRC) message or the UE can inform it's capability in these regards.

Another object of the embodiments herein is to disclose the SRS hopping schemes, wherein the hopping is as per UE capability reported by UEs to a base station (e.g., gNB or the like).

Another object of the embodiments disclosed herein is to configure a subset of hopping and perform a specific hopping scheme only within that subset, thereby avoiding overlapping and interference.

Another object of the embodiments disclosed herein is to provide a comb and a CS hopping schemes for the SRS. The CS values of two ports hop within the same subset part of a given subset in the same comb across OFDM symbols. Further, the CS values of two ports are all within one subset part of the given subset in a given OFDM symbol and hop across different subset parts of the same given subset across different OFDM symbols and remain in the same comb across the OFDM symbols. Furthermore, the CS values of two ports are all within one subset part of the given subset in a given OFDM symbol and hop across different subset parts of different subset across different OFDM symbols and remain in the same comb across different OFDM symbol.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the scope thereof, and the embodiments herein include all such modifications.

### Solution to Problem

Accordingly, the embodiments herein provide methods for managing a CS hopping in a wireless network. The method includes determining, by a User Equipment (UE), that a cyclic shift hopping is enabled and a hopping finer granularity is disabled upon determining that a base station configures the UE for SRS transmission using at least one parameter. Further, the method includes performing, by the UE, at least one of: initializing a PSRG with a value that is a function of a UE specific identifier (ID), using a pseudo random generator that resets itself once every N slots or N frames, using the PSRG run to generate a value, using one or more of a slot number, a frame number SFN, subcarrier spacing, OFDM symbol number in a slot, a number of symbols per slot, a number of slots per frame, a SRS symbol number in the slot for every SRS OFDM symbol to compute an unique number and generate a CS value corresponding to that SRS OFDM symbol using the unique number. Further, the method includes performing, by the UE, at least one of: using the CS value to generate a complex exponential sequence and using a Zadoff chu and complex exponential sequence transmitting the SRS over a subcarrier region in an OFDM symbol.

In an embodiment, the at least one parameter includes at least one of: a UE specific ID for SRS, a transmissioncomb, a cyclicshifthopping parameter that indicate if cyclic shift hopping feature is enabled or not, a parameter corresponding to hopping finer granularity, a hopping subset, a subsetCS that indicate allowed CS values of a subset, a pseudo random generator (PSRG) reinitialized every N frames or N slots, a parameter configuring a Zadoff Chu sequence to be used, and a parameter helping the UE to determine a region of subcarriers to transmit the SRS, and a parameter that includes cyclic shift values or cyclic shift offset values for cyclic shift hopping, wherein the parameter is a bitmap of 1s and 0s.

In an embodiment, the at least one parameter comprises at least one of: a UE specific ID for SRS, a transmissioncomb, a cyclicshifthopping parameter that indicate if cyclic shift hopping feature is enabled or not, a hopping subset, a subsetCS (may be called by setCS as well) of CS offset values that indicate allowed CS offset values of a subset, where the Cs offset values from the subset will be added to existing CS values to determine the final CS values, a pseudo random generator (PSRG) reinitialized every N frames or N slots, a parameter configuring a Zadoff Chu sequence to be used, and a parameter helping the UE to determine a region of subcarriers to transmit the SRS.

In an embodiment, using the unique number, the UE selects a CS offset value from the hopping subset subsetCS, wherein the UE calculates as many CSs as there are ports of the UE, wherein the CS value of a port of UE has two parts; wherein the first part is calculated such that the first part of CS values for all ports are equidistant over the range of allowable CS values, which is zero to maximum CS value minus one, wherein the exact CS values of the first part of a port is determined by higher layers configuration, wherein the UE adds a second part of CS value to the first part of CS values of all ports, wherein the addition of the first part and second part is under modulo of maximum CS value, wherein the second part of the CS value is the selected CS offset values from hopping subset or subsetCS, using the unique value derived from the PSRG output for the SRS OFDM symbol wherein the CS value of each port determines the complex exponential sequence, wherein the complex exponential sequence along with the determined Zadoff-Chu sequence is used to transmit the SRS of the port of the UE over the determined/configured region of subcarriers.

Accordingly, the embodiments herein provide methods for managing a comb hopping in a wireless network. The method includes determining, by a UE, that a comb offset hopping is enabled upon determining a base station configures the UE for SRS transmission using at least one parameter. Further, the method includes performing, by the UE, at least one of: initializing a PSRG with a value that is a function of a UE specific identifier (ID), using a pseudo random generator resets itself once every N slots or N frames, using the PSRG run to generate a value, using a slot number, a frame number SFN, subcarrier spacing, OFDM symbol number, number of symbols per slot, a number of slots per frame, SRS symbol number in the slot for every OFDM symbol, a quantity that is dependent on higher layer parameter hopping WithRepetition, higher layer parameter repetitionFactor, OFDM symbol number in a slot to compute an unique number, wherein the unique number will be used to determine the comb used in that SRS OFDM symbol and generating a CS value. Further, the method includes performing, by the UE, at least one of: using a CS configured separately to generate a complex exponential sequence and using a Zadoff chu and complex exponential sequence transmit the SRS over subcarrier regions in an OFDM symbol.

In an embodiment, the at least one parameter comprises at least one of: a UE specific ID for SRS, a transmissioncomb for KTC (transmissioncombnumber), a transmissioncomb for transmissioncomboffset, a freqscalingfactor for PF, a startrRBindex, and a freqdomainshift and a parameter that include available hop locations which can be comb offset values for comb offset wherein the parameter is a bitmap of 1s and 0s.

In an embodiment, the base station configures the UE with a parameter comprising a nrofSymbols and a startPosition that determines a location of SRS symbols in the slot, wherein the base station configures a repetitionFactor.

In an embodiment, the base station configures a parameter comprising a comboffsethopping for SRS transmission, wherein the comboffsethopping has a subset setComb that contains comb offset values.

In an embodiment, the base station configures a hopping WithRepetition.

In an embodiment, the starting position in frequency domain of the comb of SRS is a sum of four quantities, wherein the first quantity is a sum of fifth quantity and sixth quantity, wherein the sixth quantity is a sum of seventh quantity, eight quantity and ninth quantity, wherein sum of seventh, eighth and ninth quantity is modulo KTC, wherein the ninth quantity uses the unique number to pick a comb offset value from the subset setComb, and wherein the starting position of the comb changes every SRS OFDM symbol.

In an embodiment, the quantity is the SRS symbol number if hoppingwithrepetition is not configured. The quantity is the product of the repition factor and floor operation of the ratio of srs symbol number and repetition factor. The floor operation of a number is the greatest integer less than the number.

Accordingly, the embodiments herein provide a UE including a CS hopping handling controller coupled with a processor and a memory. The CS hopping handling controller is configured to determine that a cyclic shift hopping is enabled and a hopping finer granularity is disabled upon determining that a base station configures the UE for SRS transmission using at least one parameter. Further, the CS hopping handling controller is configured to perform at least one of: initializing a PSRG with a value that is a function of a UE specific identifier (ID), using a pseudo random generator resets that itself once every N slots or N frames, using the PSRG run to generate a value, using one or more of a slot number, a frame number SFN, subcarrier spacing, OFDM symbol number in a slot, number of symbols per slot, number of slots per frame, SRS symbol number in the slot for every SRS OFDM symbol to compute an unique number and generating a CS values per set corresponding to that SRS OFDM symbol using the unique number. Further, the CS hopping handling controller is configured to perform at least one of: using the CS value to generate a complex exponential sequence and using a Zadoff chu and complex exponential sequence transmit the SRS over a subcarrier region in an OFDM symbol.

Accordingly, the embodiments herein provide a UE including a CS hopping handling controller coupled with a processor and a memory. The CS hopping handling controller is configured to determine that a comb offset hopping is enabled upon determining a base station configures the UE for SRS transmission using at least one parameter. Further, the CS hopping handling controller is configured to perform at least one of: initializing a PSRG with a value that is a function of a UE specific identifier (ID), using a pseudo random generator resets itself once every N slots or N frames, using the PSRG run to generate a value, using one or more of a slot number, a frame number SFN, subcarrier spacing, OFDM symbol number in a slot, number of symbols per slot, SRS symbol number in the slot for every OFDM symbol a quantity that is dependent on higher layer parameter hoppingWithRepetition, higher layer parameter repetitionFactor, OFDM symbol number in a slot to compute an unique number, wherein the unique number will be used to determine the comb used in that SRS OFDM symbol and generating a CS value. Further, the CS hopping handling controller is configured to perform at least one of: using a CS configured separately to generate a complex exponential sequence and using a Zadoff chu and complex exponential sequence transmit the SRS over subcarrier regions in an OFDM symbol.

Accordingly, the embodiments herein provide methods for managing a CS hopping in a wireless network. The method includes determining, by a UE, that a cyclic shift hopping is enabled and a hopping finer granularity is disabled upon determining that a base station configures the UE for SRS transmission using at least one parameter. Further, the method includes determining, by the UE, that a number of ports of the UE is four and maximum cyclic shift is six. Further, the method includes performing, by the UE, at least one of: initializing a PSRG with a value that is a function of a UE specific ID, using a PSRG that resets itself once every N slots or N frames, using the PSRG run to generate a value using one or more of a slot number, a frame number, a SFN, subcarrier spacing, an OFDM symbol number in a slot, a number of symbols per slot, number of slots per frame, and a SRS symbol number in a slot for every SRS OFDM symbol to compute an unique number and generating two sets of identical two CS values per set corresponding to a SRS OFDM symbol using the unique number. Further, the method includes performing, by the UE, at least one of: using the CS value to generate a complex exponential sequence and using a Zadoff chu and complex exponential sequence transmit the SRS over a subcarrier region in an OFDM symbol.

In an embodiment, the at least one parameter comprises at least one of: a UE specific ID for the SRS, a transmissioncomb, a cyclicshifthopping parameter that indicate if a cyclic shift hopping feature is enabled or not, a hopping subset, a subsetCS that indicate allowed CS values of a subset, a PSRG reinitialized every N frames or N slots, a parameter configuring a Zadoff Chu sequence to be used, and a parameter helping the UE to determine a region of subcarriers to transmit the SRS.

In an embodiment, the at least one parameter comprises at least one of: a UE specific ID for the SRS, a transmissioncomb, a cyclicshifthopping parameter that indicate if a cyclic shift hopping feature is enabled or not, a hopping subset, a subsetCS of CS offset values that indicate allowed CS offset values, where the CS offset values from the subset will be added to existing CS values to determine the final CS values, a PSRG reinitialized every N frames or N slots, a parameter configuring a Zadoff Chu sequence to be used, and a parameter helping the UE to determine a region of subcarriers to transmit the SRS.

In an embodiment, using the unique number, the UE selects a CS offset value from the hopping subset subsetCS, wherein the UE computes two identical sets of two CSs each when the maximum CS is six and UE has four ports; wherein a first set corresponds to ports 1001 and 1003 and a second set corresponds to ports 1000 and 1002, wherein the first set is transmitted in Comb X and the second set is transmitted in Comb Y, wherein the CS value of a port in any of the two identical sets of UE has two parts, wherein a first part is computed such that the first part of CS values for the two ports are equidistant over a range of allowable CS values, which is zero to maximum CS value minus one, wherein the exact CS values of the first part of any port is determined by higher layers configuration; wherein the UE adds a second part of CS value to the first part of CS values of all ports, wherein the addition of the first part and second part is under modulo of maximum CS value, wherein the second part of the CS value is the selected CS offset values from hopping subset or subsetCS using the unique number derived from the PSRG output for the SRS OFDM symbol, wherein the CS value of each port determines the complex exponential sequence, and wherein the complex exponential sequence along with the determined Zadoff-Chu sequence is used to transmit the SRS of the port of the UE over the determined region of subcarriers, wherein the configured region of subcarriers determines the comb X and the comb Y, wherein for combX the seventh quantity is the sum of transmissioncomboffset and half of KTC (transmissioncombnumber), wherein the sum is modulo transmissioncombnumber; wherein the ninth quantity is zero; wherein the starting position of the comb is in a frequency domain, wherein for the comb Y, the seventh quantity is just the transmissioncomboffset, wherein the ninth quantity is zero, and wherein the starting position of the comb is in the frequency domain.

Accordingly, the embodiments herein provide methods for managing a comb hopping in a wireless network. The method includes determining, by a UE, that a comb offset hopping is enabled upon determining a base station configures the UE for SRS transmission using at least one parameter. Further, the method includes determining that a number of ports of the UE is four and a maximum CS value is six. Further, the method includes performing, by the UE, at least one of: initializing a PSRG with a value that is a function of a UE specific identifier (ID), using a pseudo random generator resets itself once every N slots or N frames, using the PSRG run to generate a value, using one or more of a slot number, a frame number, a SFN, subcarrier spacing, an OFDM symbol number in a slot, a number of symbols per slot, a SRS symbol number in a slot for every OFDM symbol, number of slots per frame, a quantity that is dependent on a higher layer parameter hopping WithRepetition, a higher layer parameter repetitionFactor, and an OFDM symbol number in a slot to compute an unique number, wherein the unique number is used to determine a comb offset value associated with two combs, wherein a first comb is comb X and a second comb is comb Y, wherein the comb X is associated with ports 1001 and 1003, wherein a comb Y is associated with ports 1000 and 1002, wherein comb X and comb Y are used in that SRS OFDM symbol and changes with SRS OFDM symbol if hopping WithRepetition is not set to repetition, wherein comb x and comb Y will change across a set of every repetitionFactor number of SRS OFDM symbols and will be constant within the set of repetitionFactor number of SRS OFDM symbols if hopping WithRepetition is set to repetition, wherein the CS values used for the comb X and ports 1001 and 1003 are two CS values distributed evenly over allowable CS values 0 to max cyclic shift value minus unity, and one of the CS values is configured with the help of a parameter that is configured by higher values; wherein the CS values used for comb Y and ports 1000 and 1002 are the same set of CS values used for Comb X. Further, the method includes performing, by the UE, at least one of: using a CS configured separately to generate a complex exponential sequence and using a Zadoff chu and complex exponential sequence transmit the SRS over subcarrier regions in an OFDM symbol.

In an embodiment, the at least one parameter comprises at least one of: a UE specific ID for SRS, a transmissioncomb for KTC (transmissioncombnumber), a transmissioncomb for transmissioncomboffset, a freqscalingfactor for PF, a startrRBindex, and a freqdomainshift.

In an embodiment, the base station configures the UE with a parameter comprising a nrofSymbols and a startPosition that determines a location of SRS symbols in the slot, wherein the base station configures a repetitionFactor.

In an embodiment, the base station configures a parameter comprising a comboffsethopping for SRS transmission, wherein the comboffsethopping has a subset setComb that contains comb offset values.

In an embodiment, the base station configures a hopping WithRepetition.

In an embodiment, the starting position in frequency domain of the combX of SRS is a sum of four quantities, wherein the first quantity is a sum of fifth, and sixth quantity, where in sixth quantity is a sum of seventh, eight quantity and ninth quantity, wherein sum of seventh, eighth and ninth quantity is modulo KTC, wherein the ninth quantity uses the unique number to pick a comb offset value from the subset setComb; wherein the starting position of the comb changes every SRS OFDM symbol, if hopping WithRepetition is not set to repetition, wherein the starting position of combX will change across a set of every repetitionFactor number of SRS OFDM symbols and will be constant within the set of repetitionFactor number of SRS OFDM symbols if hopping WithRepetition is set to repetition. For combX the seventh quantity is the sum of transmissioncomboffset and half of KTC (transmissioncombnumber), wherein the sum is modulo transmissioncombnumber. In another embodiment, for the comb X, the seventh quantity is the sum of transmissioncomboffset and half of KTC (transmissioncombnumber) and the tenth quantity and eleventh quantity, wherein the sum is modulo transmissioncombnumber.

In an embodiment, the starting position in frequency domain of the combY of SRS is a sum of four quantities, wherein the first quantity is a sum of fifth, and sixth quantity, where in sixth quantity is a sum of seventh, eight quantity and ninth quantity, wherein sum of seventh, eighth and ninth quantity is modulo KTC, wherein the ninth quantity uses the unique number to pick a comb offset value from the subset setComb; wherein the starting position of the comb Y changes every SRS OFDM symbol; wherein for combY the seventh quantity is the transmissioncomboffset, if hopping WithRepetition is not set to repetition, wherein the starting position of combX will change across a set of every repetitionFactor number of SRS OFDM symbols and will be constant within the set of repetitionFactor number of SRS OFDM symbols if hopping WithRepetition is set to repetition; wherein for combY the seventh quantity is the transmissioncomboffset wherein, for the combY, the seventh quantity is the sum of transmissioncomboffset. a 12th quantity and a thirteenth quantity wherein the sum is modulo transmissioncombnumber.

In an embodiment, the quantity is the SRS symbol number if hoppingwithrepetition is not configured, wherein the quantity is derived from the repition factor, and a floor of the ratio of SRS symbol number and the repetition factor. The floor of a number is the greatest integer less than the number,

Accordingly, the embodiments herein provide a UE including a CS hopping handling controller coupled with a processor and a memory. The CS hopping handling controller is configured to determine that a cyclic shift hopping is enabled and a hopping finer granularity is disabled upon determining that a base station configures the UE for SRS transmission using at least one parameter. Further, the CS hopping handling controller is configured to determine that a number of ports of the UE is four and maximum cyclic shift is six. Further, the CS hopping handling controller is configured to perform at least one of: initialize a PSRG with a value that is a function of a UE specific ID, use a pseudo random generator (PSRG) that resets itself once every N slots or N frames, use the PSRG run to generate a value using one or more of a slot number, a frame number, a System Frame Number (SFN), subcarrier spacing, an OFDM symbol number in a slot, a number of symbols per slot, number of slots per frame, and a SRS symbol number in a slot for every SRS OFDM symbol to compute an unique number and generating two sets of identical two CS values per set corresponding to a SRS OFDM symbol using the unique number. Further, the CS hopping handling controller is configured to perform at least one of: use the CS value to generate a complex exponential sequence and use a Zadoff chu and complex exponential sequence transmit the SRS over a subcarrier region in an OFDM symbol.

Accordingly, the embodiments herein provide a UE including a CS hopping handling controller coupled with a processor and a memory. The CS hopping handling controller is configured to determine that a comb offset hopping is enabled upon determining a base station configures the UE for SRS transmission using at least one parameter. Further, the CS hopping handling controller is configured to determine that a number of ports of the UE is four and a maximum CS value is six. Further, the CS hopping handling controller is configured to perform at least one of: initialize a PSRG with a value that is a function of a UE specific identifier (ID), use a pseudo random generator resets itself once every N slots or N frames, using the PSRG run to generate a value, using one or more of a slot number, a frame number, a SFN, subcarrier spacing, an OFDM symbol number in a slot, a number of symbols per slot, a SRS symbol number in a slot for every OFDM symbol, number of slots per frame, a quantity that is dependent on a higher layer parameter hopping WithRepetition, a higher layer parameter repetitionFactor, and an OFDM symbol number in a slot to compute an unique number, wherein the unique number is used to determine a comb offset value associated with two combs, wherein a first comb is comb X and a second comb is comb Y, wherein the comb X is associated with ports 1001 and 1003, wherein a comb Y is associated with ports 1000 and 10012, wherein comb X and comb Y are used in that SRS OFDM symbol and changes with SRS OFDM symbol if hopping WithRepetition is not set to repetition, wherein comb x and comb Y will change across a set of every repetitionFactor number of SRS OFDM symbols and will be constant within the set of repetitionFactor number of SRS OFDM symbols if hopping WithRepetition is set to repetition, wherein the CS values used for the comb X and ports 1001 and 1003 are two CS values distributed evenly over allowable CS values 0 to max cyclic shift value minus unity, and one of the CS values is configured with the help of a parameter that is configured by higher values; wherein the CS values used for comb Y and ports 1000 and 1002 are the same set of CS values used for Comb X. Further, the CS hopping handling controller is configured to perform at least one of: using a CS configured separately to generate a complex exponential sequence and using a Zadoff chu and complex exponential sequence transmit the SRS over subcarrier regions in an OFDM symbol.

### Advantageous Effects of Invention

According to at least one embodiment of the present disclosure, efficient SRS transmission and reception can be made possible by avoiding overlap and interference by applying appropriate comb and CS hopping to SRS.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 depicts examples of SRS time/frequency structures, according to prior arts;

FIG. 2 depicts a scenario, wherein comb based frequency multiplexing of SRS from two different devices are performed assuming comb-2, according to prior arts;

FIG. 3 depicts a scenario, wherein the SRS is transmitted once every KTC subcarriers in frequency domain, according to prior arts;

FIG. 4 depicts the process of cyclic shift hopping, according to embodiments as disclosed herein;

FIG. 5 depicts the process of comb hopping, according to embodiments as disclosed herein;

FIG. 6 depicts a process of performing joint CS and comb hopping, according to embodiments as disclosed herein;

FIG. 7 depicts a process of performing joint CS and comb hopping, according to embodiments as disclosed herein;

FIG. 8 depicts a process of performing joint CS and comb hopping, according to embodiments as disclosed herein;

FIG. 9 depicts a process of performing joint CS and comb hopping, according to embodiments as disclosed herein;

FIG. 10 depicts example of how PSRG for CS/comb hopping, according to embodiments as disclosed herein;

FIG. 11 depicts example of PSRG for CS/comb hopping, according to embodiments as disclosed herein;

FIG. 12 depicts an example of a subset configuration for comb-offset hopping, according to embodiments as disclosed herein;

FIG. 13 illustrates first embodiment related to comb hopping, where the CSs in the comb are as per release 17 of 3gpp, according to the embodiment as disclosed herein;

FIG. 14 illustrates second embodiment comb hopping, where the CSs in the comb are as per release 17 of 3gpp, according to the embodiment as disclosed herein;

FIG. 15 illustrates third embodiment related to the comb hopping, where the CSs in the comb are as per release 17 of 3gpp, according to the embodiment as disclosed herein;

FIG. 16 illustrates the CS hopping in a given comb, according to the embodiment as disclosed herein;

FIG. 17 is a flow chart illustrating a CS hopping, according to embodiments as disclosed herein.

FIG. 18 is a flow chart illustrating a comb hopping, according to embodiments as disclosed herein.

FIG. 19 is a flow chart illustrating a CS hopping for Frac CS, according to embodiments as disclosed herein.

FIG. 20 is a flow chart illustrating a comb hopping for Frac CS, according to embodiments as disclosed herein; and

FIG. 21 shows various hardware components of a UE, according to the embodiments as disclosed herein.

FIG. 22 illustrates a structure of a terminal in a wireless communication system according to an embodiment of the present disclosure; and

FIG. 23 illustrates a structure of a base station in a wireless communication system according to an embodiment of the present disclosure.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The embodiments herein achieve a method for managing a CS hopping in a wireless network. The method includes determining, by a User Equipment (UE), that a cyclic shift hopping is enabled and a hopping finer granularity is disabled upon determining that a base station configures the UE for SRS transmission using at least one parameter. Further, the method includes performing, by the UE, at least one of: initializing a PSRG with a value that is a function of a UE specific identifier (ID), using a pseudo random generator that resets itself once every N slots or N frames, using the PSRG run to generate a value, using one or more of a slot number, a frame number SFN, subcarrier spacing, OFDM symbol number in a slot, number of symbols per slot, number of slots per frame, SRS symbol number in the slot for every SRS OFDM symbol to compute an unique number and generating a CS values corresponding to that SRS OFDM symbol using the unique number. Further, the method includes performing, by the UE, at least one of: using the CS value to generate a complex exponential sequence and using a Zadoff chu and complex exponential sequence transmit the SRS over a subcarrier region in an OFDM symbol.

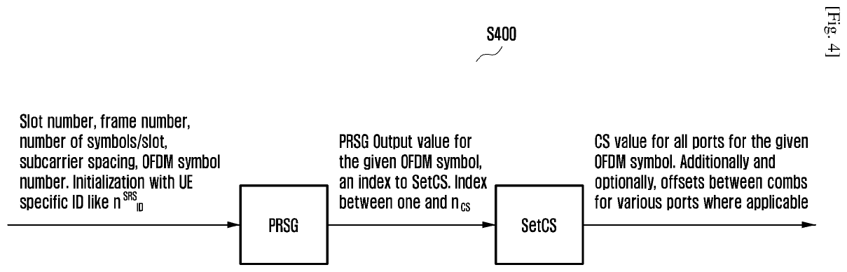

The embodiments herein achieve SRS hopping schemes. Referring now to the drawings, and more particularly to FIGS. 4 through 21, where similar reference characters denote corresponding features consistently throughout the figures, there are shown at least one embodiment.

The following MATLAB notation is followed herein to access matrices:
a) A matrix is represented by BOLD UPPERCASE vectors by bold lowercase and scalars by normal font.
b) A.*B is a matrix with same dimensions as A, B obtained by element-wise multiplication of A and B.
c) N×N FFT matrix F_{N} is defined as F(i,j)=e, fΔij/N, 0≤i, j≤N−1. The a^{th} column of F_{N} is denoted by f_{a,N}. The cyclically shifted version of f_{a,N} (upward) by b positions is denoted by f^{(b)}_{a,N}.
d) The cyclically shifted version of a column vector x(upward) by b positions is denoted by x^{(b)}.

Estimate of x is denoted as

$$\hat{x} \cdot *$$

denotes conjugate.

One of the items being discussed in SRS for Release-18 is enhancements for SRS in 8TX and Time Division Duplex (TDD) Coherent Joint Transmission (TDD-CJT) operation. In the TDD-CJT operation, as it is in the context of multiple transmission and reception point (mTRP), reduction of interference is needed.

In a current Pseudo-random sequence generation (PRSG), a Generic pseudo-random sequence is defined by a length-31 Gold sequence. The output sequence of length M_{PN} is defined by c(n)=(x₁(n+N_{C})+x₂(n+N_{C}) mod 2 where sequences x₁(n) and x₂(n) are generated as follows:

x₁(n+31)−(x₁(n+3)+x₁(n))mod 2

x₂(n+31)=(x₂(n+3)+x₂(n+2)+x₂(n+1)+x₂(n)mod 2
where N_{C}=1600 and x₁ will be initialized with x₁(0)=1, x₁(1)=x₁(2)= . . . =x₁(30)=0 and initialization of second sequence is denoted by

$${c}_{i n i t} = {\sum }_{j = 0}^{30} {x}_{2} ( i ) {2}^{i} .$$

Note that the outputs are all either 0 or 1 at the nth time instant. New values of x₁ are modulo 2 sum of Nₓ₁=2 past values of x₁. New values of x₂ are modulo 2 sum of Nₓ₂=4 past values of x₂. C (n) is the modulo 2 sum of values of x₁ and x₂ at a different instant n+N_{c}. In some cases, the ports and CSs of the UEs are assigned in different combs. This happens for a four-port UE when n^{CS,max}_{SRS} is six as six cyclic shifts cannot be divided equally among four ports and assigned in a comb. It also happens to a four port UE if the CS in RRC message n^{CS}_{SRS} is between 0.5 n^{CS,max}_{SRS} and n^{CS,max}_{SRS}−1.

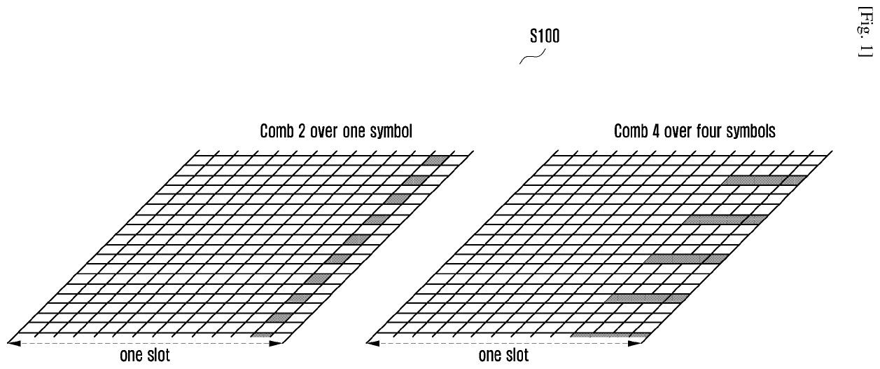

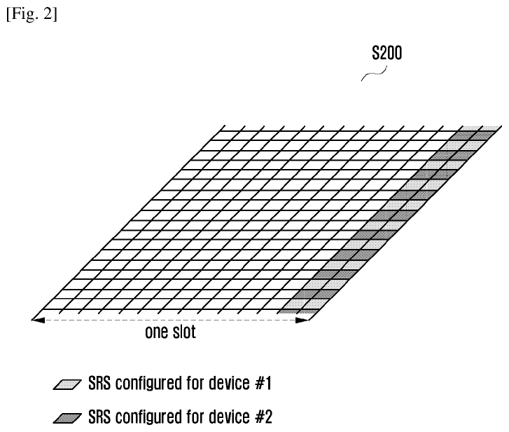

The SRS is transmitted on every N^{th} subcarrier, where N can take the values two or four (“comb-2” and “comb-4,” respectively). FIG. 1 depicts examples of SRS time/frequency structures (S100). The SRS transmissions from different devices can be frequency multiplexed within the same frequency range by being assigned different combs corresponding to different frequency offsets. For comb-2, that is, when the SRS is transmitted on every second subcarrier, two SRS can be frequency multiplexed. In the case of comb-4, up to four SRS can be frequency multiplexed. FIG. 2 depicts a scenario (S200), wherein comb based frequency multiplexing of SRS from two different devices are performed assuming comb-2.

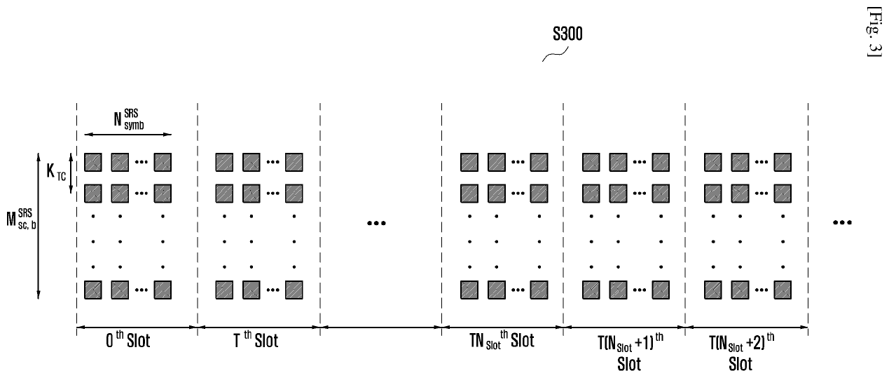

FIG. 3 depicts a scenario (S300), wherein the SRS is transmitted once every K_{TC} subcarriers in frequency domain. In every slot, it has

$${N}_{\text{?}}^{\text{?}} OFMD$$

$$\text{?} \text{indicates text missing or illegible when filed}$$

symbols, and per OFDM symbol has a length of

$${M}_{\text{?}}^{\text{?}}$$

$$\text{?} \text{indicates text missing or illegible when filed}$$

a configurable periodicity of T slots and SRS has the same value across slots and OFDM repetitions. The nth subcarrier value is

$${e}^{\frac{j 2 π c ( p ) n}{s}} {\overline{r}}_{u , ν} ( n ) where {\overline{r}}_{\text{?}} ( n )$$

$$\text{?} \text{indicates text missing or illegible when filed}$$

is the Zadoff-Chu sequence, c(p) is the cyclic shift (CS) for the pth port/user (denoted by

$${n}_{\text{?}}^{\text{?}}$$

$$\text{?} \text{indicates text missing or illegible when filed}$$

and S is period of cyclic shift or also maximum cyclic shift (denoted by

$${n}_{\text{?}}^{\text{?}}$$

$$\text{?} \text{indicates text missing or illegible when filed}$$

in 3GTPP TS 38.211 V17.0.0 (2021-12), titled physical channels and modulation (Release 17) below and can take values of 8,12,6 depending on K_{tc}.

The prior art (i.e., 3GPP TS 38.211 V17.0.0 (2021-12), titled physical channels and modulation (Release 17)). All innovation on SRS features in the patent disclosure has SRS in prior art as baseline. The higherlayer parameters, transmissioncomb, transmissioncombnumber K_{TC}, traqnsmissioncomboffset K̅_{TC}, freqscalingfactor, startRBindex, freqdomainshift, nrofsymbols, startposition, repetitionfactor, hoppingwithrepetition are all defined as per prior art.

A concept of subset for comb offsets or cyclic shifts when comb offset hopping or cyclic shift hopping is configured, respectively, has been adopted. There is a coexistence problem of cyclic shift hopping and comb-offset hopping when legacy UEs who cannot perform cyclic shift hopping and/or comb-offset hopping, and Rel-18 UEs who can perform hopping scheme are scheduled in the same time resource. For cyclic shift hopping, if SRS for legacy UE and Rel-18 UE performing cyclic shift hopping are allocated at the same comb in the same time resource, although initial cyclic shift values are different for legacy and Rel-18 UEs, due to the cyclic shift hopping, hopped cyclic shift of Rel-18 UE could be overlapped with that of legacy UE's one, which cause interference to legacy UE. A similar situation could happen for comb-offset hopping when SRS for legacy and Rel-18 UE are allocated at the same time resource.

Cyclic shift hopping with finer granularity: The cyclic shift hopping with finer granularity has can be adopted. For SRS cyclic shift hopping, support finer time-delay-domain granularity, e.g., α_i=2π (n_“SRS”\hat{ }(“cs”, i))/(n_“SRS” \hat{ }(“cs”, “max”))+2π (n_“SRS”\hat{ }(“cs”, offset))/(KXn_“SRS”\hat{ }(“cs”, “max”)), where n_“SRS”\hat{ }(“cs”, offset) can be randomly chosen from {0,1, . . . [symbol] K×n [symbol] _“SRS”\hat{ }(“cs”, “max”)−1} at each SRS transmission. The finer granularity above only applies to the cyclic shift offsets when cyclic shift hopping is enabled. If a subset for cyclic shifts is configured, this feature cannot be configured. The above is a UE optional feature. Another issue is how to determine the value of K which decides a finer granularity.

Embodiments herein disclose SRS hopping schemes, wherein comb and/or cyclic shift hopping can be used in intra-slot or inter-slot scenarios or both for reducing/randomizing interference. Embodiments herein disclose SRS hopping schemes, wherein the hopping takes care of legacy UEs in that certain comb/CS values can be skipped, and the skipped values or the region where comb/CS hopping is done can be configured by MAC-CE, DCI or RRC message or the UE can inform it's capability in these regards. Embodiments herein disclose SRS hopping schemes, wherein the hopping is as per UE capability reported by UEs to the gNB.

Two new sequences c₁(n) and c₂(n) can be generated just like c(n). c₁(n) and c₂(n) can be used for CS hooping and comb hopping respectively. The generation of c₁(n) and c₂(n) can be from the same x₁ and x₂, but in different combinations of the same (different Nₓ₁, Nₓ₂, N_{c} for each sequence, selected past values of x₁ and x₂ etc). The generation of c₁(n) and c₂(n) can be from different x₁ and x₂ and different combinations of the same (different Nₓ₁, Nₓ₂, N_{c} for each sequence, selected past values of x₁ and x₂etc). c(n) can be generated in a different way or same as prior art and used to generate a combined cyclic shift (CS) and/or comb hopping. x₁ and x₂ can be initialized by a constant value and/or cell ID n^{cell}_{ID}, SRS sequence ID n^{SRS}_{ID}, C-RNTI or any other new ID. Initialization can be reset at the frame boundary or every N frames or N slots or based on system frame number where N is configurable.

Embodiments herein disclose sets of CSs and combs. A set of CSs (or CS offsets which need to be added to CSs) called as SetCS and a set of comb offsets called as SetComb. The former has n_{CS} entries while the latter has n_{comb} entries. The PSRG output is an index value which is between one and n_{CS} if it indexes into SetCS and/or another index value between one and n_{comb} if it indexes into SetComb.

SetCS: n_{CS} can be equal to n^{CS,max}_{SRS}, the maximum cyclic shift and the index just picks an appropriate CS (cyclic shift) or CS offset value from the SetCS. To multiplex with legacy UEs, some CSs need to be excluded from the SetCS. The exclusion list can be configured by RRC and/or MAC-CE, DCI via PDCCH. In such cases the number of entries n_{CS} can be less than n^{CS,max}_{SRS}. For instance, if maxCS n^{CS,max}_{SRS}=12, and a legacy UE occupies CSs 0 and 6, SetCS can be {1,2,3,4,5,7,8,9,10,11}, so that the CSs don't clash with legacy CS. In both the above cases once the CS is finalized, CSs for other ports are finalized in an equidistant manner (that is configurable) over the whole or a subregion of 0-n^{CS,max}_{SRS}. A configured offset can be added as well. Sometimes, per-port CS needs to be configured explicitly for all ports. In that case, n_{CS} can be less than, greater than or equal to n^{CS,max}_{SRS} and each entry in SetCS will be an ordered mini-set of CSs for each port of the UE. Additionally, and optionally, where ports have to be mapped across combs, embodiments herein can have one or more comb offset information in each entry as well.

SetCS and SetComb can be designed in various ways (embodiments).

SetComb: n_{comb} can be equal to K_{TCe}, the number of configured combs and the index just picks an appropriate comb value from the SetComb. To multiplex with legacy UEs, some combs can be allocated to legacy Ues. These need to be excluded from the SetComb. The exclusion list can be configured by RRC and/or MAC-CE, DCI via PDCCH. In such cases the number of entries n_{comb} can be less than KTC. In some cases, the entries in SetComb can be an ordered mini-set of one or more comb offset values to which the ports of the UEs need to be assigned.

SetCsComb: A set where entries are ordered sets of CS and comb values. Let the number of entries be n_{cs-comb}.

FIG. 4 depicts the process (S400) of cyclic shift hopping. Inputs like the slot number, frame number, number of symbols/slots, subcarrier spacing, OFDM symbol number and so on are provided to the PRSG. Further, initialization is performed with a UE specific ID like

$${n}_{ID}^{SRS}$$

or a new ID. The output value of the PRSG for the given OFDM symbol is given as an index to SetCS, wherein the index is between one and n_{cs}. The SetCS gives the Cs value for all ports for the given OFDM symbol. Additionally, the SetCS can give the offsets between the combs for the various ports, where applicable.

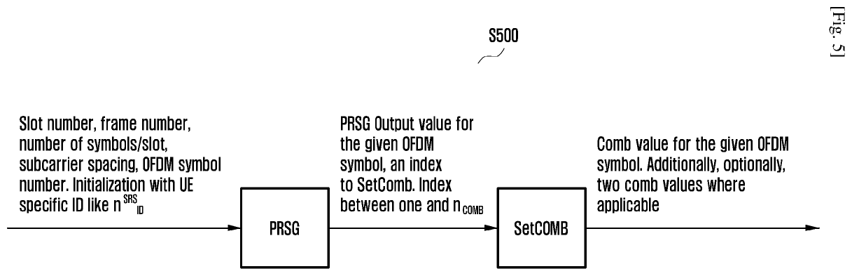

FIG. 5 depicts the process (S500) of comb hopping. Inputs like the slot number, frame number, number of symbols/slots, subcarrier spacing, OFDM symbol number and so on are provided to the PRSG. Further, initialization is performed with a UE specific ID like

$${n}_{ID}^{SRS}$$

or a new ID. The output value of the PRSG for the given OFDM symbol is given as an index to SetCOMB, wherein the index is between one and n_{comb}. The SetComb provides the comb value for the given OFDM symbol. In an embodiment herein, the SetComb can provide two comb values, where applicable.

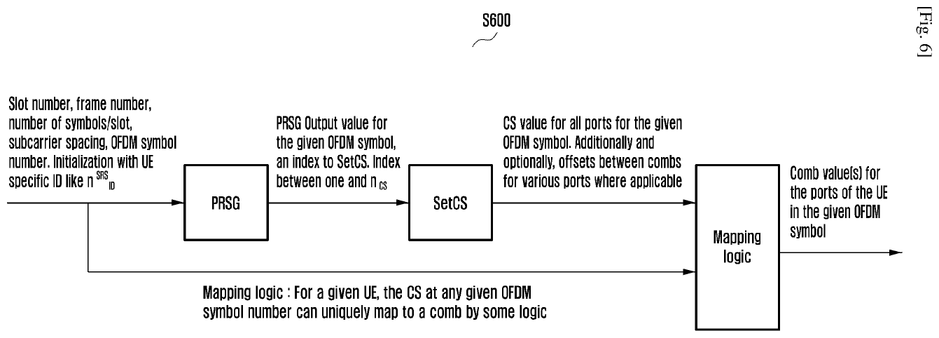

FIG. 6 depicts a process (S600) of performing joint CS and comb hopping. Inputs like the slot number, frame number, number of symbols/slots, subcarrier spacing, OFDM symbol number and so on are provided to the PRSG. Further, initialization is performed with a UE specific ID like

$${n}_{ID}^{SRS}$$

or a new ID. The PRSG outputs a value for the given OFDM symbol, an index to SetCS, wherein the index is between one and n_{CS} and the output is given to the SetCS. The SetCS provides the CS value for all ports for the given OFDM symbol. In an embodiment herein, the SetCS can provide the offsets between combs for various ports, where applicable. The output of the SetCS can use a suitable mapping logic to determine comb value(s) for the ports of the UE in the given OFDM symbol. In an embodiment herein, the mapping logic can be as follows: for a given UE, the CS at any given OFDM symbol number can uniquely map to a comb by some logic.

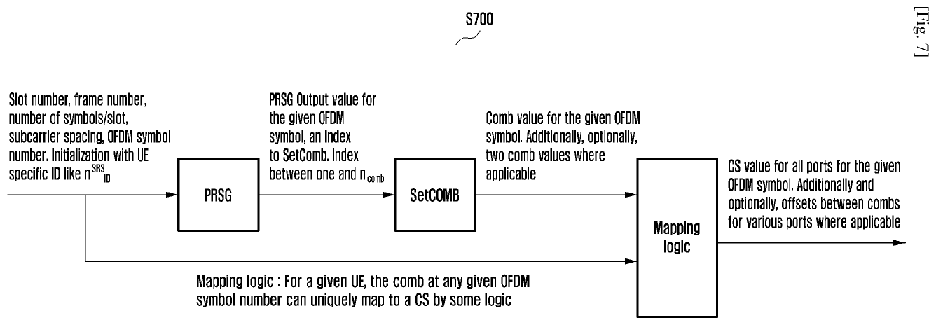

FIG. 7 depicts a process (S700) of performing joint CS and comb hopping. Inputs like the slot number, frame number, number of symbols/slots, subcarrier spacing, OFDM symbol number and so on are provided to the PRSG. Further, initialization is performed with a UE specific ID like

$${n}_{ID}^{SRS}$$

or a new ID. The PRSG outputs a value for the given OFDM symbol, an index to SetComb, wherein the index is between one and n_{comb} and the output is given to the SetComb. The SetComb provides the comb value for the given OFDM symbol. In an embodiment herein, the SetComb can provide two comb values, where applicable. The output of the SetCOMB can use a suitable mapping logic to determine CS value(s) for the given OFDM symbol. In an embodiment herein, the offsets between combs for various ports, where applicable. In an embodiment herein, the mapping logic can be as follows: for a given UE, the comb at any given OFDM symbol number can uniquely map to a CS by some logic.

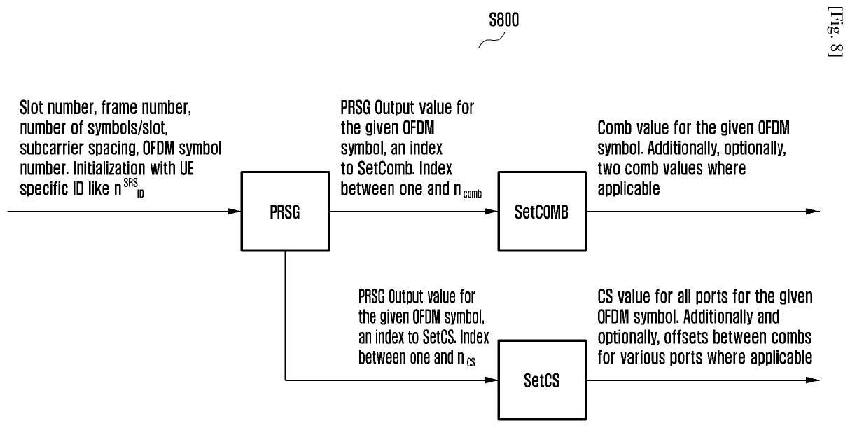

FIG. 8 depicts a process (S800) of performing joint CS and comb hopping. Inputs like the slot number, frame number, number of symbols/slots, subcarrier spacing, OFDM symbol number and so on are provided to the PRSG. Further, initialization is performed with a UE specific ID like

$${n}_{ID}^{SRS}$$

or a new ID. The PRSG provides a first output value for the given OFDM symbol, an index to SetComb, wherein the index is between one and n_{comb}. The PRSG provides a second output value for the given OFDM symbol, an index to SetCS, wherein the index is between one and n_{CS}. The first output is provided to a SetCOMB, which outputs a comb value for the given OFDM symbol. In an embodiment herein, the SetCOMB can provide two comb value, where applicable. The second output can be provided to a SetCS, which outputs the CS value for all ports for the given OFDM symbol. In an embodiment herein, the SetCS can provide the offsets between combs for various ports, where applicable.

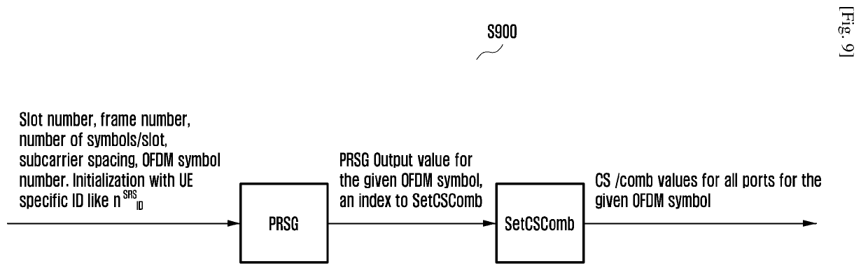

FIG. 9 depicts a process (S900) of performing joint CS and comb hopping. Inputs like the slot number, frame number, number of symbols/slots, subcarrier spacing, OFDM symbol number and so on are provided to the PRSG. Further, initialization is performed with a UE specific ID like

$${n}_{ID}^{SRS}$$

or a new ID. The PRSG outputs a value for the given OFDM symbol, which can be an index to SetCSComb. The PRSG output can be provided to the SetCSComb, which provides CS/comb values for all ports for the given OFDM symbol.

### PRSG for CS/Comb Hopping:

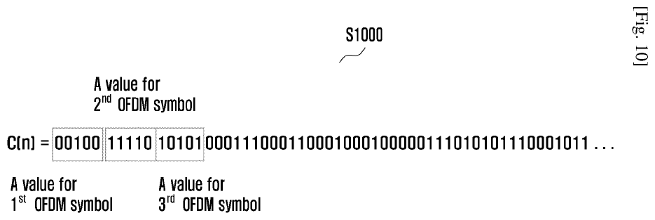

A=5 in this illustration and example values for the OFDM symbols are depicted in FIG. 10. In an embodiment herein, the value of A bits modulo n_{CS} or n_{comb} can provide an index into SetCS or SetComb. In an embodiment herein, the value of A bits modulo n_{CS-comb} can provide and index into SetCSComb. Let S be the OFDM symbol number. Then, the PRSG output value is

$$( {\sum }_{m = 0}^{A - 1} c ( AS + m ) {2}^{m} ) mod ( {n}_{cs} )$$

or

$$( {\sum }_{m = 0}^{A - 1} c ( AS + m ) {2}^{m} ) mod ( {n}_{comb} ) .$$

In a special case, 2^{A}−1 can be equal to n_{cs} or n_{comb} Or n_{cs-comb}.

PRSG for joint CS and/Comb hopping:

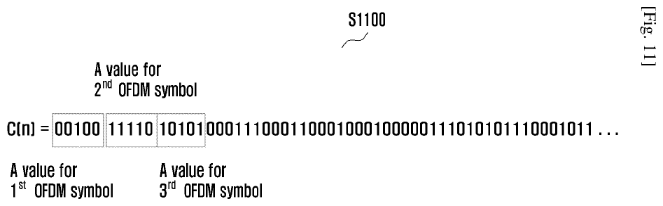

A=5 in this illustration and example values (S1100) for the OFDM symbols are depicted in FIG. 11. Let S be the OFDM symbol no. The first B bits can be used for CS hopping and the remaining A-B bits for comb hopping. Then, the PRSG output value is

$$( {\sum }_{m = 0}^{B - 1} c ( BS + m ) {2}^{m} ) mod ( {n}_{cs} )$$

or

$$( {\sum }_{m = B}^{A - 1} c ( ( A - B ) S + m ) {2}^{m} ) mod ( {n}_{comb} ) .$$

Alternatively, A bits can be used for CS hopping and B bits from another region (denoted by offset Z) for comb hopping. Then PRSG output value is

$$( {\sum }_{m = 0}^{A - 1} c ( AS + m ) {2}^{m} ) mod ( {n}_{cs} )$$

$$( {\sum }_{m = 0}^{B - 1} c ( Z + BS + m ) {2}^{m} ) mod ( {n}_{comb} ) .$$

In a special case, 2^{A}−1 or 2^{B}−1 can be equal to n_{cs} or n_{comb}.

### UE Capability:

The gNB can trigger either CS hoping or Comb hopping or both or neither based on UE capability feedback it receives from UE. The feature can be configured by RRC message also.

### UE Capability:

Embodiments herein disclose multiple CS hopping/comb hopping/joint CS and comb hopping schemes, which can have separate corresponding UE capabilities, or a single UE capability including at least more than or equal to one of proposed schemes (ie, CS hopping/comb hopping/joint CS and comb hopping any embodiment), or combination of them.

### gNB Configuration:

The gNB can configure the UE with a hopping scheme in one of the following ways:
a) Either one of the schemes (as depicted in FIGS. 4-7, i.e., “CS hopping” or “Comb offset hopping” or “Joint CS and comb hopping (any embodiment)”) can be configured by the RRC.
b) One of the schemes (as depicted in FIGS. 4-7, i.e., “CS hopping” or “Comb offset hopping” or “Joint CS and comb hopping (any embodiment)”) can be configured by the RRC.
c) One of the schemes (as depicted in FIGS. 4-9, i.e., “CS hopping”, “Comb offset hopping”, “joint scheme 1”, “joint scheme 2”, “joint scheme 3”, “joint scheme 4”) can be configured by RRC.

And then, the granularity of the RRC parameter can be per SRS resource (meaning different SRS resource can have either CS hopping or Comb offset hopping or Joint CS-comb hopping), per SRS resource set (meaning SRS resources in same set has same scheme either CS hopping or Comb offset hopping or joint, but SRS resources in different set can have different scheme), per some SRS resource sets (e.g., for the case of 1T4R, 1T8R, antenna switching, multiple sets are needed, hence the same scheme would be applied to some SRS resource sets), per BWP, per serving cell, or else. The gNB configuration can be via RRC message, MAC-CE or through PDCCH DCI.

### Comb/CS Hopping:

Comb/CS hopping can be with or without group and/or sequence hopping. It can be related to UE capability as well. The reinitialization of c(·) can be once in N slots or frames or be dependent on system frame number (SFN) and can be configured by the RRC, MAC-CE, and DCI.

### Hopping of Multiple Ports:

### Sequence ID

$${n}_{ID}^{SRS}$$

is defined in an SRS-resource and is associated with all ports of the resource. CS hopping of ports be dependent on sequence ID. Does that mean all the ports CS hop such that CS distance between the ports is same always.? That could be one possibility. In an embodiment herein, all the ports CS hop such that CS distance between the ports is always the same. A new ID can be used which gives rules for CS hopping of each port of a UE or SRS-resource independently. In an embodiment herein, the sequence ID or a new ID can be used to CS hop the first port or one particular port of the UE or SRS-resource and a rule can assign the other ports of UE or SRS-resource across other combs and CS such that they do not collide with other SRS-resources or ports of UE. Similarly, the existing sequence ID or a new ID can be used for comb hopping. The new ID can be configured by RRC configuration for both comb/CS hopping.

Assume 12 cyclic shifts (CSs) or maxCS is 12, and as per legacy a two port UE/SRS resource is assigned in equidistant manner. Example SRS-resource0 will take CSs 0 and 6 in a comb. This could be a legacy UE and will have no hopping across say Four OFDM SRS symbols in a slot t1, t2, t3, t4. Now, SRS-resource1 and SRS-resource2, each having two ports and assigned to two different UEs is involved in hopping. The sub-region of CSs available in this comb is 1,2,3,4,5,7,8,9,10,11. The SRS-resource1 in time t1 can have a port assigned to CS 1 in this comb. The rule is the other port is 6 CSs away (modulo operation), so its second port is at CS 7 in this comb. In same t1, the CS hopping rule says SRS-resource2 says one port is hopped to CS 3 and the rule automatically assigns the other port to CS 9. In time t2, the CS hopping could assign one port to CS 5 and as per the rule the other port is at CS 11. In t2, SRS-resource2 can have a CS hopping such that its port is at CS 4 and other port is as per rule six CS away, i.e., CS 10. This example depicts how only one port hops based on sequence ID, other ports are automatically assigned as per a rule, and CS hopping happens in a sub region that avoids legacy UEs or SRS-resources assigned to them. The rule can be extended to combs in a similar way. This is depicted in table 1, which depicts the CS allocation strategy of multiple ports.

TABLE 1

| | SRS-resource 0 | | SRS-resource 1 | | SRS-resource 2 | |
|---|---|---|---|---|---|---|
| time | Port 0 | Port 1 | Port 0 | Port 1 | Port 0 | Port 1 |
| t1 | 0 | 6 | 1 | 7 | 3 | 9 |
| t2 | 0 | 6 | 5 | 11 | 4 | 10 |
| t3 | 0 | 6 | 2 | 8 | 1 | 7 |
| t4 | 0 | 6 | 4 | 10 | 3 | 9 |

SRS resource 0 is as per legacy. CS of Port 0 of SRS-resource1/2 hops according to CS hopping, while CSs of port1 of SRS-resource1/2 is such that they are 6 CSs away from their respective port0. This depicts multiplexing with legacy UEs and also multiplexing in a sub region of CSs.

### Comb Hopping of Multiple Ports:

Table 2 depicts the comb allocation strategy, ktc=4. there are four combs

TABLE 2

| time | Comb 1 | Comb 2 | Comb 3 | Comb 4 |
|---|---|---|---|---|
| t1 | (1, 2) | (3, 4) | (5, 6) | (7, 8) |
| t2 | (1, 2) | (7, 6) | (3, 8) | (5, 4) |
| t3 | (1, 2) | (5, 8) | (7, 4) | (3, 6) |

(a, b) means the two ports of srs-resource a and two ports of srs-resource b are paired together in the same comb. The two ports of srs-resource a will have CSs 0,6 and two ports of srs-resource b have CSs 3,9 (The Cs values are for example purposes). In this example, the srs-resources hop on various combs across time but maintain the same CSs. Also, it shows how to multiplex with legacy Ues (in this example Comb1 is dedicated). It can be extended to changes of CSs of each SRS-resource along with comb hopping. When number of ports=4 and maxCS=6, the ports are distributed in different combs. Also, if the number of ports is four and

$${n}_{SRS}^{CS} ∈ \{ {n}_{SRS}^{CS , max} / 2 , … , {n}_{SRS}^{CS , max} - 1 \} ,$$

for such cases, the examples of CS hopping (as discussed previously) or comb hopping or a combination of both in a straightforward fashion can be used.

### Hopping Across OFDM Symbols, Slots:

Comb hopping/CS hopping or both can be dependent only on OFDM symbol index and associated with a UE capability. This means it can change within R symbols (a repetition factor) or can be configured by RRC, MAC-CE, DCI. The value of R=1 is a special case. Comb hopping/CS hopping can depend on a particular OFDM symbol index within R, which is configurable. Comb hopping/CS hopping or both can be dependent only on OFDM symbol index but be constant in R and associated with a UE capability or can be configured by RRC, MAC-CE, DCI. Comb hopping/CS hopping or both can be dependent only on within a slot (intra slot) and associated with a UE capability or can be configured by RRC, MAC-CE, DCI. Comb hopping/CS hopping or both can be constant in a slot but vary across slots (inter slot) and associated with a UE capability or can be configured by RRC, MAC-CE, DCI. Comb hopping/CS hopping or both can be in the context of one or more of frequency hopping, partial sounding (defined by PF or FreqScalingFactor in standards), no frequency hopping, no partial sounding and each combination can be associated with UE capability or can be configured by RRC, MAC-CE, DCI.

To avoid possible overlapping and interference, embodiments herein configure a subset of hopping, and perform a specific hopping scheme only within the subset. For generating a subset, the subset shall be a general solution for all possible cases of SRS transmission considering different number of ports (e.g., 1, 2, or 4) and different value of comb size (e.g., 2, 4, or 8) & corresponding maximum value of cyclic shift (e.g., 8, 12, or 6), and the subset shall not have a negative impact on flexible scheduling from the gNB side, considering both legacy non-hopping UEs and Rel-18 UEs with hopping. Hence, the RRC configuration for subset can include available hop locations which can be comb offset values for comb offset hopping and cyclic shift values for cyclic shift hopping.

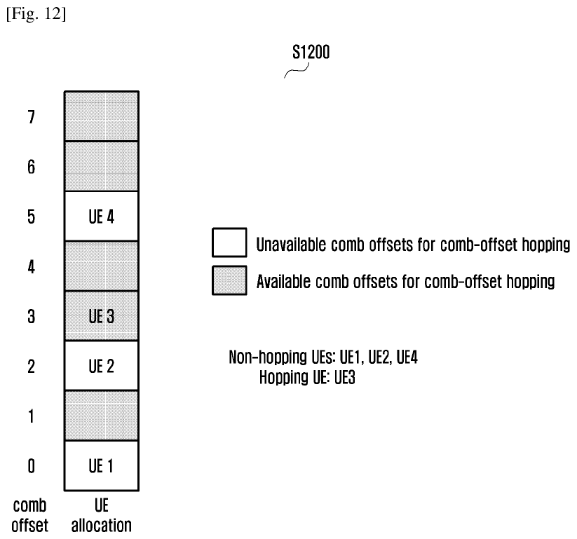

FIG. 12 depicts an example (S1200) of a subset configuration for comb-offset hopping. In FIG. 12, among the 4 UEs, there are 3 non-hopping UEs (i.e., UE1, UE2, and UE4) and 1 hopping UE (i.e., UE2), wherein all UEs are configured with a single SRS port. It is assumed that all UEs are configured with the same SRS port, i.e., all UEs are allocated with the same cyclic shift. Then, from UE3's perspective, the available hop locations, i.e., subset of comb-offsets, are depicted as a shaded box in FIG. 12, which includes the original location of comb-offset from UE3 as well as other empty locations of comb-offsets where other UEs are not allocated. Those available hop locations can be configured by RRC parameter based on a certain RRC signalling format, e.g., sequence of possible hop location as {1, 3, 4, 6, 7} which is absolute location, or {0, 1, 3, 4, 6} which is relative location from UE3's original location. It is similar to the case of cyclic shift hopping, and a detailed signalling structure can be determined.

Information is delivered from the gNB to the UE for supporting a subset configuration. For this, one thing is noted that, for both cyclic shift hopping and comb offset hopping, the original location of the hopping UE's cyclic shift value or comb offset value is always considered as an available hop locations in a subset, because the gNB configures initial cyclic shift values or comb offset values by considering for both hopping UEs and non-hopping UEs to minimize the interference and maximize channel estimation performance from the gNB side. Then, there is no reason why hopping UE is configured with a subset for hopping except initial cyclic shift values or comb offset values.

Hence, the subset for hopping can always include an initial cyclic shift of comb offset value without explicit RRC configuration. Then, one of the RRC configuration signalling is to introduce a bitmap which n−1 bits are required for comb-n where n can be 2, 4, or 8 for comb offset hopping, or which n−1 bits are required for maximum cyclic shift value of n where n can be 8, 12, or 6 for comb-2, comb-4, or comb-8, respectively. Considering relative location, for comb-offset hopping in FIG. 12, UE3 is configured with 7-bit bitmap as {1, 0, 1, 1, 0, 1, 0} meaning that possible values of comb-offset from its initial location are 1, 3, 4, and 6 which can be expressed as “1” in the bitmap.

Embodiments herein can support RRC configured subset for cyclic shift hopping or comb-offset hopping; for example, bitmap based configuration for available locations. For comb-offset hopping, bitwidth is n−1 bits for comb-n where n can be 2, 4, or 8. For cyclic shift hopping, bitwidth is n−1 bits for maximum cyclic shift value of n where n can be 8, 12, or 6 for comb-2, comb-4, or comb-8, respectively.

Cyclic Shift Hopping with Finer Granularity:

If a larger K value is adopted, then the gNB shall prepare much finer cyclic shift detection region in order to distinguish each hop with finer granularity because Rel-18 UE who supports cyclic shift hopping with finer granularity can be multiplexed with the legacy UE (who cannot perform cyclic shift hopping) and/or Rel-18 UE (who supports cyclic shift hopping without finer granularity). Hence, a fixed value of K is enough to support finer granularity, which can be an integer and larger than 1, i.e., K=2.

For cyclic shift hopping with finer granularity, embodiments herein support a fixed value of K=2. Embodiments herein can also support higher values of K>2. Considering all agreed features during Rel-18 SRS enhancement for TDD CJT, a new formula for two hopping schemes can be generated. For cyclic shift hopping, the following aspects can be considered to generate a hopping formula:
a. Subset configuration for cyclic shift hopping: This decides possible hopping locations of cyclic shift.
b. Cyclic shift with finer granularity: This decides the granularity of hopping.

The above two features are not configured at the same time.

By using above, the hopping formula of cyclic shift hopping is determined as follows:

$${k}_{CShop} = ( {\sum }_{m = 0}^{7} c \{ 8 ( ( {n}_{f} mod {N}_{reinit} ) {N}_{slot}^{frame , μ} {N}_{symb}^{slot} + {n}_{s , f}^{μ} {N}_{symb}^{slot} + {l}_{0} + {l}^{′} ) + m \} \cdot {2}^{m} ) mod \vert {S}_{CS} \vert$$

Where
n_{f} is system frame number (SFN),
Nᵣₑᵢₙᵢₜ is re-initialization period which is fixed at 128 frames,

$${N}_{slot}^{frame , μ}$$

is the number of slots per frame for μ,

$${N}_{symb}^{slot}$$

is the number of symbols per slot,

$${n}_{s , f}^{μ}$$

l₀ is the starting OFDM symbol position of the SRS resource in the time domain,

$${l}^{′} = 0 , … , {N}_{symb}^{SRS} - 1$$

is a set of possible cyclic shift values, and |S_{CS}| is a cardinality of S_{CS}.

If a subset for cyclic shift hopping is configured, then S_{CS} is the subset, and

$$\vert {S}_{CS} \vert \leq {Kn}_{SRS}^{CS , max} ,$$

and K=1. Else if cyclicShiftHoppingFinerGranularity is configured,

$$\vert {S}_{CS} \vert \leq {Kn}_{SRS}^{CS , max} ,$$

and K is greater than 1.

Else (neither a subset nor cyclicShiftHoppingFinerGranularity is configured), S_{CS} is all possible cyclic shift values under given transmissionComb configuration, and

$$\vert {S}_{CS} \vert \leq {Kn}_{SRS}^{CS , max} ,$$

and K=1.

Based on the above, the result of cyclic shift hopping, k_{CShop}, is included in the following formula.

$${α}_{i} = 2 π \frac{{n}_{SRS}^{cs , i}}{{n}_{SRS}^{cs , max}} + 2 π \frac{{k}_{CShop}}{{Kn}_{SRS}^{cs , max}}$$

In an embodiment herein,

$${α}_{i} = 2 π \frac{{n}_{SRS}^{cs , i}}{{n}_{SRS}^{cs , max}} + 2 π \frac{{S}_{CS} ( {k}_{CShop} )}{{Kn}_{SRS}^{cs , max}}$$

Where S_{CS}(a) is the ath element of S_{CS} If cyclicShiftHoppingFinerGranularity is configured, K>1, otherwise K=1.

For comb-offset hopping, embodiments herein consider the following aspects to generate a hopping formula:
a) Subset configuration for comb-offset hopping: This decides possible hopping locations of comb-offset.
b) Hopping behaviour of comb-offset hopping with repetition: This affects whether hopping is performed for every OFDM symbol index, or the first OFDM symbol index within R repetition.

By using the above, hopping formula of comb-offset hopping is determined as follows:

$${k}_{COhop} = ( {\sum }_{m = 0}^{7} c \{ 8 ( ( {n}_{f} mod {N}_{reinit} ) {N}_{slot}^{frame , μ} {N}_{symb}^{slot} + {n}_{s , f}^{μ} {N}_{s y m b}^{slot} + {l}_{0} + ⌊ \frac{{l}^{′}}{R \cdot \overline{R}} ⌋ R \cdot \overline{R} ) + m \} \cdot {2}^{m} ) mod \vert {S}_{CO} \vert$$

Where,
n_{f} is system frame number (SFN),
Nᵣₑᵢₙᵢₜ is re-initialization period which is fixed at 128 frames,

$${N}_{slot}^{frame , μ}$$

is the number of slots per frame for μ,

$${N}_{symb}^{slot}$$

is the number of symbols per slot,

$${n}_{s , f}^{μ}$$

is the slot number within a frame for μ,
l₀ is the starting OFDM symbol position of the SRS resource in the time domain, and

$${l}^{′} = 0 , … , {N}_{symb}^{SRS} - 1$$

is an OFDM symbol index for SRS resource.

S_{CO} is a set of possible comb-offset values, and |S_{CO}| is a cardinality of S_{CO}, and, and I S_{CO}|≤K_{TC}. If a subset for comb-offset hopping is configured, then S_{CO} means the subset. Otherwise, S_{CO} is all possible comb-offset values under given transmissionComb configuration, and |S_{CO}|=K_{TC}. If repetition factor R is equal to 1 (i.e., no repetition), or combOffsetHoppingWithRepetition is configured with “Per-symbol” with R>1, then R̅=1/R, which means comb-offset hopping is performed by every OFDM symbol index during R repetitions. If combOffsetHoppingWithRepetition is configured with “per-R-Repetition”, then R̅=1, which means comb-offset hopping is performed by the first symbol index across the R repetitions.

Based on the above, the result of comb-offset hopping, k_{COhop}, is added in the following formula to determine the frequency domain starting subcarrier position.

$${\overline{k}}_{0}^{( {p}_{i} )} = {n}_{shift} {N}_{sc}^{RB} + ( {k}_{TC}^{( {p}_{i} )} + {k}_{offset}^{{l}^{′}} + {k}_{COhop} ) mod {K}_{TC}$$

In an embodiment herein,

$${\overline{k}}_{0}^{( {p}_{i} )} = {n}_{shift} {N}_{s c}^{RB} + ( {k}_{TC}^{( {p}_{i} )} + {k}_{offset}^{{l}^{′}} + {S}_{co} ( {k}_{COhop} ) ) mod {K}_{TC}$$

Where S_{CO}(k) is the kth element of S_{CO}

Embodiments herein support the following hopping formula for cyclic shift hopping (k_{CShop}) and comb offset hopping (k_{COhop}).

$${k}_{CShop} = ( {\sum }_{m = 0}^{7} c \{ 8 ( ( {n}_{f} mod {N}_{reinit} ) {N}_{slot}^{frame , μ} {N}_{symb}^{slot} + {n}_{s , f}^{μ} {N}_{symb}^{slot} + {l}_{0} + {l}^{′} ) + m \} \cdot {2}^{m} ) mod \vert {S}_{CS} \vert$$

$${k}_{COhop} = ( {\sum }_{m = 0}^{7} c \{ 8 ( ( {n}_{f} mod {N}_{reinit} ) {N}_{slot}^{frame , μ} {N}_{symb}^{slot} + {n}_{s , f}^{μ} {N}_{symb}^{slot} + {l}_{0} + ⌊ \frac{{l}^{′}}{R \cdot \overline{R}} ⌋ R \cdot \overline{R} ) + m \} \cdot {2}^{m} ) mod \vert {S}_{CO} \vert$$

### RRC Parameter:

In RAN1 #113, RRC parameters for Rel-18 MIMO has been discussed. Embodiments herein propose the Table 1. Regarding combOffsetHoppingWithRepetition, embodiments herein do not require combining with other parameter(s) (e.g., repetition factor), and the proposed configuration in Table 1 is enough to support the agreed feature. Regarding applying both hopping schemes simultaneously, separate configurations for comb-offset hopping and cyclic shift hopping are enough and have value both as “configured”. Regarding hoppingId, if a UE is configured with comb-offset hopping and cyclic shift hopping as “configured” simultaneously, a same hoppingId is applied to both hopping schemes. Similar with separate configurations for comb-offset hopping and cyclic shift hopping, separate configurations for supporting subset (i.e., combOffsetHoppingSubset and cyclicShiftHoppingSubset) are applied to each hopping scheme. For example, it is possible to configure comb-offset hopping and cyclic shift hopping simultaneously, and corresponding subset configuration(s) for one of two hopping schemes or both hopping schemes can be configured. A note “cyclicShiftHoppingSubset and cyclicShiftHoppingFinerGranularity cannot be configured at the same time” is needed to add in both cyclicShiftHoppingSubset and cyclicShiftHoppingFinerGranularity.

For RRC parameters of SRS for TDD CJT, embodiments herein disclose the table 3.

TABLE 3

| | | | | Per (UE, |
|---|---|---|---|---|
| | New or | | | cell, |
| Parameter name in the spec | existing? | Description | Value range | TRP, . . . ) |
| combOffsetHopping | New | Parameter | {Configured, Not | Per SRS |
| | | for configuring | configured} | resource |
| | | comb offset | | |
| | | hopping | | |
| cyclicShiftHopping | New | Parameter for | {Configured, Not | Per SRS |
| | | configuring | configured} | resource |
| | | cyclic shift | | |
| | | hopping | | |
| hoppingId | New | ID used to | INTEGER (0 . . . 1023) | Per SRS |
| | | initialize | | resource |
| | | pseudo random | | |
| | | comb offset | | |
| | | hopping | | |
| | | or cyclic | | |
| | | shift hopping | | |
| combOffsetHoppingWithRepetition | New | Parameter for | {Per-symbol, per- | Per SRS |
| | | configuring | R-Repetition} | resource |
| | | comb offset | | |
| | | hopping | | |
| | | time-domain | | |
| | | hopping | | |
| | | behavior for | | |
| | | repetition | | |
| | | factor R > 1 | | |
| combOffsetHoppingSubset | New | Parameter for | Bit sequence with | Per SRS |
| | | configuring | length of | resource |
| | | comb offset | transmissionComb − | |
| | | hopping | 1(transmissionComb | |
| | | subset | can be “n2”, “n4”, | |
| | | | or “n8”) | |
| cyclicShiftHoppingSubset | New | Parameter for | Bit sequence with | Per SRS |
| | | configuring | length of “maximum | resource |
| | | cyclic shift | cyclic shift with | |
| | | hopping | given comb value” − | |
| | | subset | 1(maximum | |
| | | | cyclic shift value | |
| | | | can be 8, 12, or 6 | |
| | | | for corresponding | |
| | | | to “n2”, “n4”, or | |
| | | | “n8”, respectively) | |
| cyclicShiftHoppingFinerGranularity | New | Parameter for | {enabled} | Per SRS |
| | | configuring | | resource |
| | | cyclic shift | | |
| | | hopping | | |
| | | finer | | |
| | | granularity | | |

In an embodiment, a CSs and comb values for the SRS needs to be allocated in such a way that interference in the TDD CJT for the mTRP is reduced. Usually all the CSs are within a comb. This happens when the maximum number of allowable CSs (cmax) is perfectly divisible by the no. of ports (Nap) of the UE.

But for cmax=6 and Nap=4, it is perfectly not divisible. So some ports are assigned in one comb and others in other comb. Also for the Nap=4 in some cases, the ports are allocated across two combs.

In an embodiment herein discloses the allocation of the resources like the CS and comb in the above cases in the context of the TDD CJT for the mTRP is covered. Throughout the discloser, the assumptions are Nap=4 and cmax=6 or Nap=4 and

$${n}_{SRS}^{C S} ∈ \{ {n}_{SRS}^{CS , max} / 2 , … , {n}_{SRS}^{CS , max} - 1 \}$$

and the disclosure discusses about comb and/or CS allocation strategies for the cases especially comb and/or CS hopping allocation strategies.

Where, Cmax=6 and Nap=4

The CS αᵢ for antenna port pᵢ is given as

$$= 2 π \frac{{n}_{SRS}^{CS , i}}{{n}_{SRS}^{CS , max}}$$

$${n}_{SRS}^{cs , i} = \{ \begin{matrix}( {n}_{SRS}^{cs} + \frac{{n}_{SRS}^{cs , max} ⌊ ( {p}_{i} - 1000 ) / 2 ⌋}{{N}_{ap}^{SRS} / 2} ) mod {n}_{SRS}^{cs , max} & if {N}_{ap}^{SRS} = 4 and {n}_{SRS}^{cs , max} = 6 \\ ( {n}_{SRS}^{cs} + \frac{{n}_{SRS}^{cs , max} ( {p}_{i} - 1000 )}{{N}_{ap}^{SRS}} ) mod {n}_{SRS}^{cs , max} & otherwise\end{matrix}$$

The standards call αᵢ as the CS However in this patent we will refer to

$${n}_{SRS}^{CS , i}$$

as the CS. The proposed invention call

$${n}_{SRS}^{CS , max}$$

as maximum CS, which we call as Cmax. We shall call the no. of antenna ports

$${N}_{ap}^{SRS}$$

### as Nap.

This means that the CS for

$${N}_{ap}^{SRS} = 4$$

are 0,0,3,3 (assume

$${n}_{SRS}^{CS} = 0$$

Note that there is duplication of the CSs. As we will see soon, the duplicate CSs will be allocated to different combs.

Further, for the comb allocation, the starting position determines which comb it eventually goes to and is determined by the transmission comb offset

$${k}_{-}^{-} “ TC ” ∈ \{ 0 , 1 , … , {K}_{-} “ TC ” - 1 \} .$$

Where he frequency-domain starting position (PD) is defined by

$${k}_{0}^{( {p}_{i} )} = {\overline{k}}_{0}^{( {p}_{i} )} + {n}_{offset}^{F H} + {n}_{offset}^{R P F S}$$

Where,

$${\overline{k}}_{0}^{( {p}_{i} )} = {n}_{shift} {N}_{s c}^{R B} + ( {k}_{T C}^{( {p}_{i} )} + {k}_{offset}^{{l}^{′}} ) mod {K}_{T C}$$

$${k}_{T C}^{( {p}_{i} )} = \{ \begin{matrix}( {\overline{k}}_{TC} + {K}_{TC} / 2 ) mod {K}_{TC} & if {N}_{ap}^{SRS} = 4 , {p}_{i} ∈ \{ 1001 , 1003 \} , and {n}_{SRS}^{cs , max} = 6 \\ ( {\overline{k}}_{TC} + {K}_{TC} / 2 ) mod {K}_{TC} & \begin{matrix}if {N}_{ap}^{SRS} = 4 , {p}_{i} ∈ \{ 1001 , 1003 \} , and \\ {n}_{SRS}^{cs} ∈ \{ {n}_{SRS}^{cs , max} / 2 , … , {n}_{SRS}^{cs , max} - 1 \}\end{matrix} \\ {\overline{k}}_{TC} & otherwise\end{matrix}$$

$${n}_{offset}^{F H} = {\sum }_{b = 0}^{{B}_{S R S}} {K}_{T C} {M}_{sc , b}^{S R S} {n}_{b}$$

$${n}_{offset}^{R P F S} = {N}_{sc}^{R B} {m}_{S R S , {B}_{S R S}} ( ( {k}_{F} + {k}_{hop} ) mod {P}_{F} ) / {P}_{F}$$

k_{F}∈{0,1, . . . , P_{F}−1} is given by the higher-layer parameter StartRBIndex if configured, otherwise k_{F}=0.

For cmax=6 and Nap=4 The CSs (assume

$${n}_{SRS}^{CS} = 0$$

0, 3 for ports 1000, 1002 will go to comb a (as determined by other parameters) and CSs and CSs 0,3 for ports 1001, 1003 will go to comb (a+K_{TC}/2) mod K_{TC}.

For Nap=4, ports 1001, 1003, and

$${n}_{SRS}^{CS} ∈ \{ {n}_{SRS}^{CS , max} / 2 , … , {n}_{SRS}^{CS , max} - 1 \} ,$$

the CSs for ports 1000, 1002 are 0,6 (assume

$${n}_{SRS}^{CS} = 0$$

will go to comb a (as determined by other parameters) and CSs 3,9 for ports 1001, 1003 will go to comb (a+K_{TC}/2) mod K_{TC}.

Accordingly, the embodiment herein is for a comb and a CS hopping schemes for an SRS. Where the CS values of two of the nap=4 ports in each comb hop within the same subset part of a given subset in the same comb across OFDM symbols. Further, the CS values of two ports are all within one subset part of the given subset in a given OFDM symbol and hop across different subset parts of the same given subset across different OFDM symbols and remain in the same comb across OFDM symbols. Furthermore, the CS values of two ports are all within one subset part of the given subset in a given OFDM symbol and hop across different subset parts of different subset across different OFDM symbols and remain in the same comb across different OFDM symbol.

The assumptions made for the techniques above are as follows:
a) When the CS hopping was there across OFDM symbols, the comb was the same in all OFDM symbols.
b) When the comb hopping was there across OFDM symbols, the CSs in that comb that hops was the same in all OFDM symbols.
c) Where the CS and the Comb both hop across OFDM symbols as per any embodiment of the CS hopping and comb hopping in this disclosure.

Accordingly, the embodiment herein, the plurality of the allowable CS values is divided into a first sub-set of the CS values and a second sub-set of the CS values and so on and so forth into many subsets such that the union of all these subsets is the set of all allowable CS values. The subsets and the CS are a Radio Resource Control (RRC) configured or through a MAC-control Element (MAC-CE) or through a Downlink Control Information (DCI). The CS values assigned to the two ports hop across the OFDM symbols such that each port has a CS value from one subset.

Accordingly, the embodiment herein, as an example, consider cmax=12, and the allowable CSs from 0-11. Furthermore, subset1=CSs 0,6, subset2=CSs 1,7,2,8, subset3=CSs 3,9,4,10 and subset4=CSs 5,11. In the first embodiment, there are four SRS OFDM symbols. In the first OFDM symbol CS1,7 are assigned to the two ports of the UE in the given comb. In the second OFDM symbol, the CSs 7,1 are assigned to two ports in the same comb. In the third OFDM symbol CS1,7 are assigned to the two ports of the UE in the same comb. In the fourth OFDM symbol, the CSs 7,1 are assigned to ports in the same comb.

Accordingly, the embodiment herein, the CS values hop across the OFDM symbols such that each port has the CS value from one subset in some OFDM symbols, and another subset in other OFDM symbols and so on and so forth. The CS values of the two ports essentially hop within different subsets and subsets vary in different OFDM symbols.

Accordingly, the embodiment herein, as an example, there are four SRS OFDM symbols. In the first OFDM symbol CS1,7 are assigned to the two ports of the UE in a given comb. In the second OFDM symbol, the CSs 7,1 are assigned to two ports in the same comb. In the third OFDM symbol CS2,8 are assigned to the two ports of the UE in the same comb. In the fourth OFDM symbol, the CSs 8,2 are assigned to the two ports.

Accordingly, the embodiment herein, the subset has at least one set of two CS values that are equidistant in the range of 0, . . . , cmax−1, where cmax is the maximum number of the CS value or maximum no. of allowable CS values, wherein the CS values of the two ports are assigned from one such set from the subset, wherein the CS values of the two ports hop within the set across OFDM symbols, wherein the set can be the same or different across OFDM symbols if the subset has more than one such set. In another embodiment the CS values assigned to the ports can hop within one or more sets of one or more subsets across OFDM symbols. The CS values always are in one comb across OFDM symbols.

Accordingly, the embodiment herein, as an example, there are four SRS OFDM symbols. In the first OFDM symbol CS1,7 are assigned to the two ports in a given comb. In the second OFDM symbol, the CSs 9,3 are assigned to ports in the same comb. In the third OFDM symbol CS2,8 are assigned to the two ports in the same comb. In the fourth OFDM symbol, the CSs 10,4 are assigned to two ports in the same comb.

Accordingly, the embodiment herein, for the disclosed Comb Hopping (Generalization), the frequency-domain starting position

$${k}_{0}^{( {p}_{i} )}$$

is defined by

$${k}_{0}^{( {p}_{i} )} = {\overline{k}}_{0}^{( {p}_{i} )} + {n}_{offset}^{F H} + {n}_{offset}^{R P F S} where$$

$${\overline{k}}_{0}^{( {p}_{i} )} = {n}_{s hift} {N}_{s c}^{R B} + ( {k}_{T C}^{( {p}_{i} )} + {k}_{offset}^{{l}^{′}} + {Af}_{L U T} ( {f}_{h o p} ) ) mod {K}_{T C}$$

$${k}_{T C}^{( {p}_{i} )} = \{ \begin{matrix}( {\overline{k}}_{TC} + {K}_{T C} / 2 + {Bg}_{LUT} ( {g}_{hop} ) + CX ( . ) ) mod {K}_{T C} & if COND 1 is TRUE \\ ( {\overline{k}}_{TC} + {Dh}_{LUT} ( {h}_{hop} ) + EY ( . ) ) mod {K}_{T C} & if COND 2 is TRUE \\ ( {\overline{k}}_{TC} ) & otherwise\end{matrix}$$

$${n}_{offset}^{F H} = {\sum }_{b = 0}^{{B}_{S R S}} {K}_{T C} {M}_{sc , b}^{S R S} {n}_{b}$$

$${n}_{offset}^{R P F S} = {N}_{sc}^{R B} {m}_{SRS , {B}_{S R S}} ( ( {k}_{F} + {k}_{hop} ) mod {P}_{F} ) / {P}_{F}$$

Where, k_{F}∈{0,1, . . . , P_{F}−1} is given by the higher-layer parameter StartRBIndex if configured, otherwise k_{F}=0; In what follows,

$${\overline{k}}_{0}^{( {p}_{i} )}$$

will be called as first quantity, n_{offset}^{FH} will be called second quantity, n_{offset}^{RPFS} is third quantity,

$${n}_{shift} {N}_{sc}^{RB}$$

as fifth quantity,

$$( {k}_{T C}^{( {p}_{i} )} + {k}_{offset}^{{l}^{′}} + {Af}_{LUT} ( {f}_{hop} ) ) .$$

as sixth quantity,

$${k}_{T C}^{( {p}_{i} )}$$

as seventh quantity,

$${k}_{offset}^{{l}^{′}}$$

as eight quantity. All these quantities are defined in 3GPP TS 38.211 V17.0.0 (2021-12), titled physical channels and modulation (Release 17). The new quantities, pertaining to this patent are, Af_{LUT}(fhop) as ninth quantity, Bg_{LUT}(gₕₒₚ) as tenth quantity, CX(·) as eleventh quantity, Dh_{LUT}(hhop) as twelfth quantity and EY(·) as thirteenth quantity.

Further A,B,C,D,E are all Flags to turn ON or OFF a corresponding feature and take values 0 or 1 to give different embodiments. The f_{LUT} is a lookup table of the f hopping values. The fₕₒₚ takes a value (between 1 and f) based on OFDM symbol number, system frame number, slot number and any other UE/SRS ID like RNTI etc. Similarly, the g_{LUT} is a lookup table of the g hopping values. The gₕₒₚ takes a value (between 1 and g) based on OFDM symbol number, system frame number, slot number and any other UE/SRS ID like RNTI etc. The h_{LUT} is a lookup table of h hopping values. The hₕₒₚ takes a value (between 1 and h) based on OFDM symbol number, system frame number, slot number and any other UE/SRS ID like RNTI etc, etc.

Furthermore, the proposed discloser define, α₁=Bg_{LUT}(gₕₒₚ) and α₂=Dh_{LUT}(hₕₒₚ). X(·) and Y(·) are functions providing offset values, X(·) is a function or look-up table can take one of α₂, symbol number, slot number, frame number, any UE identity like cell ID

$${n}_{I D}^{cell} , SRS$$

sequence identity

$${n}_{I D}^{S R S} , C - RNTI ,$$

or a new ID. Similarly, Y(·) is a function or look-up table can take one of α₁, symbol number, slot number, frame member, any UE identity like cell ID

$${n}_{ID}^{cell} ,$$

SRS sequence identity

$${n}_{I D}^{S R S} ,$$

C-RNTI, or a new ID. Note that with the proposed method

$${k}_{T C}^{( {p}_{i} )}$$

has different values across OFDM symbols and this is achieved by having a k̅_{TC} as constant and g_{LUT}(gₕₒₚ) or h_{LUT}(hₕₒₚ) or Af_{LUT}(fₕₒₚ) which changes values across OFDM symbols. This is equivalent to not having g_{LUT}(gₕₒₚ) or h_{LUT}(hₕₒₚ) or Af_{LUT}(fₕₒₚ) and instead have a k̅_{TC} that changes across OFDM symbols.

In another embodiment for COND1 and COND2, the p_i∈{1001, 1003} can be associated with COND2 and p_i∈{1000, 1002} with COND1.

In another embodiment any two ports can be associated with COND2 and other two ports with COND1.

$$if ( {N}_{a p}^{S R S} = 4 , {p}_{i} ∈ \{ 1001 , 1003 \} , and {n}_{S R S}^{cs , max} = 6 ) OR$$

$$( if {N}_{a p}^{S R S} = 4 , {p}_{i} ∈ \{ 1001 , 1003 \} , {n}_{S R S}^{cs , max} ∈ \{ 8 , 12 \} and$$

$${n}_{S R S}^{c s} ∈ \{ {n}_{S R S}^{cs , max} / 2 , … , {n}_{S R S}^{cs , max} - 1 \} ) is TRUE$$

$$then COND 1 is TRUE$$

$$Endif$$

$$if ( {N}_{a p}^{S R S} = 4 , {p}_{i} ∈ \{ 1000 , 1002 \} , and {n}_{S R S}^{cs , max} = 6 ) OR$$

$$( if {N}_{a p}^{S R S} = 4 , {p}_{i} ∈ \{ 1000 , 1002 \} , {n}_{S R S}^{cs , max} ∈ \{ 8 , 12 \} and$$

$${n}_{S R S}^{c s} ∈ \{ {n}_{S R S}^{cs , max} / 2 , … , {n}_{S R S}^{cs , max} - 1 \} ) is TRUE$$

$$then COND 2 is TRUE$$

$$endif$$

Accordingly the embodiment herein, the ports are deployed in two different combs (k_TV\hat{ }((p_i)) have two different values for the Four ports) in the prior art that are K_“TC”/2 combs apart under modulo cmax. Alternately, we can have the ports in combs that are not K_“TC”/2 combs apart under modulo cmax. The embodiments are selected by turning ON or OFF the 4 flags, A,B,C,D,E.

In prior art there are two ports in each of the two combs for Nap=4. So thus the discloser addresses how the CSs are assigned and hopped for the two ports in a comb.

The two ports are either {1000,1002} or {1001, 1003}. The disclosed invention have any combinations of two ports from the ports 1000-1003.

FIG. 13 illustrates the first embodiment related to comb hopping (S1300), where the CSs in the comb are as per release 17 of 3gpp, according to the embodiment as disclosed herein.

Referring to the FIG. 13, illustrates that the two

$${\overline{k}}_{0}^{( {p}_{i} )}$$

are K_{TC}/2 values apart under modulo cmax as they hop across OFDM symbols. The legacy UEs can use

$${\overline{k}}_{TC} = 1 , 3 , 5 , 7$$

and avoid a clash of combs with the disclosed method. Further, selects B=C=D=E=0,

$$A = 1. {\overline{k}}_{T C}$$

is the comb offset.

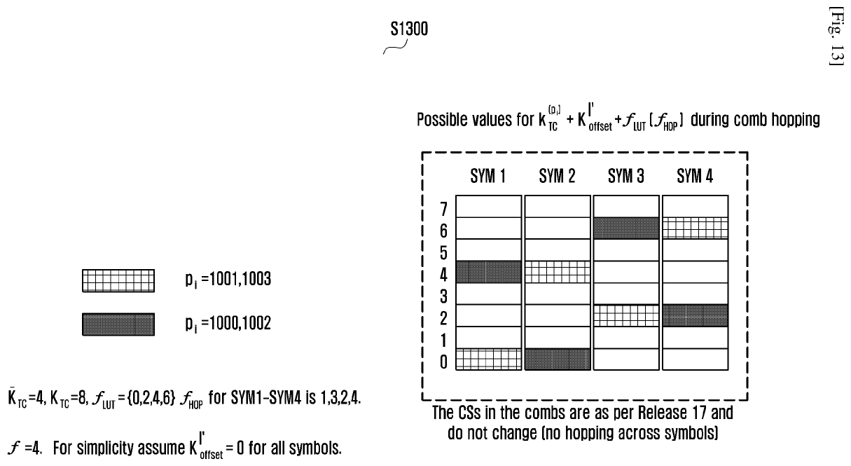

FIG. 14 illustrates second embodiment comb hopping (S1400), where the CSs in the comb are as per release 17 of 3gpp, according to the embodiment as disclosed herein. Referring to the FIG. 14, illustrates that the two

$${k}_{0}^{( {p}_{i} )}$$

are not necessarily K_{TC}/2 values apart under modulo cmax as they hop across OFDM symbols. Note that the two

$${k}_{0}^{( {p}_{i} )}$$

can coincide while hopping in any OFDM symbol for

$${N}_{ap}^{SRS} = 4$$

and

$${n}_{SRS}^{CS} ∈ \{ {n}_{SRS}^{CS , m ax} / 2 , … , {n}_{SRS}^{CS , m ax} - 1 \} .$$

This is because in prior art the CSs (CSs) in these combs are different. However, for

$${N}_{ap}^{SRS} = 4$$

and cmax=6, they should not coincide as in prior art the CSs are the same in the two combs. The discloser assumes the CSs are as per prior art and no CS hopping. The legacy UEs can use

$${\overline{k}}_{TC} = 1 , 5 ,$$

and avoid a clash of combs with the disclosed method. Further, selects B=E=1, C=D=A=0.

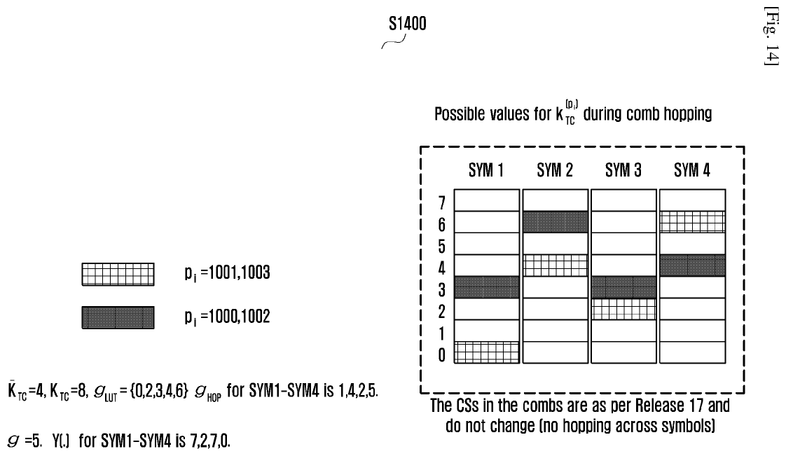

FIG. 15 illustrates the third embodiment related to the comb hopping (S1500), where the CSs in the comb are as per release 17 of 3gpp, according to the embodiment as disclosed herein.

Referring to the FIG. 15, illustrates that the two

$${k}_{0}^{( {p}_{i} )}$$

are K_{TC}/2 values apart under modulo cmax as they hop across OFDM symbols. The legacy UEs can use k̅_{TC}=1,3,5,7 and avoid a clash of combs with disclosed method. Further, selects B=E=1, C=D=A=0.

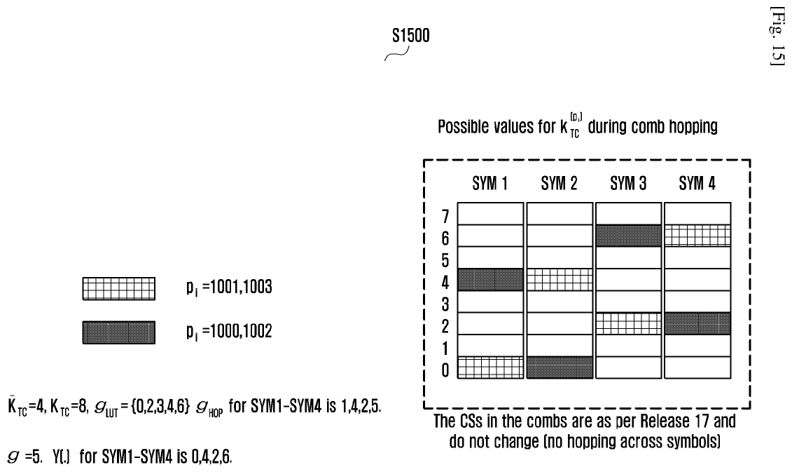

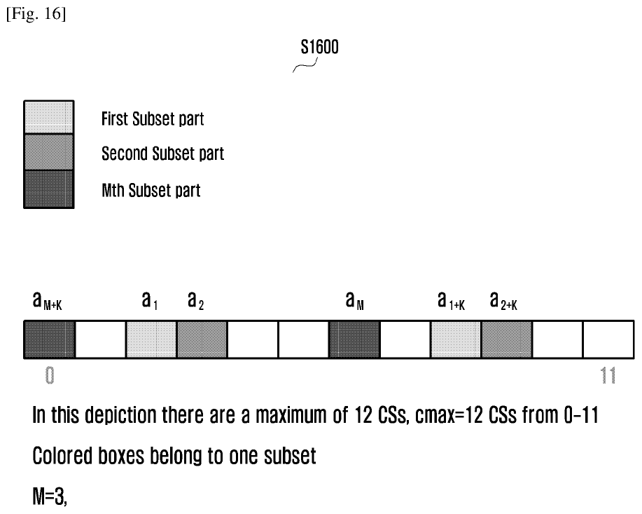

FIG. 16 illustrates (S1600) the CS hopping in a given comb, according to the embodiment as disclosed herein.

Referring to the FIG. 16, in a second set of CS hopping embodiments illustrates a plurality of the allowable CS values is split into a first sub-set of the CS values and a second sub-set of the CS values and so on and so forth into many subsets. Each sub-set of the CS values is divided into two subset parts. The number of subset parts is M, and k=cmax/2, where cmax is the maximum value of the CS or a number of allowable CSs. The all subset parts will have equal number of the CS values, wherein the CS values a₁, a₁+k are in the first subset part, a₂, a₂+k are in the second subset part, . . . , a_{M}, a_{M}+k, are in the Mth subset part Wherein M is greater than or equal to unity, wherein some or all or none of a₁, a₂, . . . , a_{M} are continuous, where in the “+” operation is under modulo of cmax. The two ports are assigned values from one subset part of the subset in any OFDM symbol, the subsets and the CSs are the RRC configured or through the MAC-CE or through the DCI.

In a first embodiment, the CS values of two ports hop within the same subset part of a given subset in the same comb across OFDM symbols. In a second embodiment, the CS values of two ports of the are all within one subset part of the given subset in a given OFDM symbol and hop across different subset parts of the same given subset across different OFDM symbols and remain in the same comb across OFDM symbols. In a third embodiment, the CS values of two ports are all within one subset part of the given subset in a given OFDM symbol and hop across different subset parts of different subset across different OFDM symbols and remain in the same comb across different OFDM symbols.

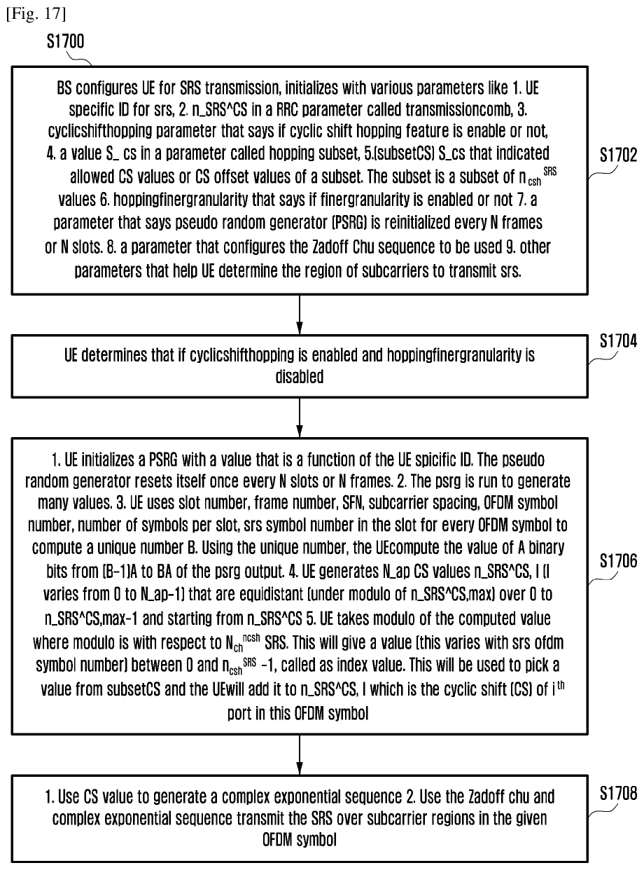

FIG. 17 is a flow chart (S1700) illustrating a CS hopping, according to embodiments as disclosed herein.

At S1702, the base station (BS) configures the UE for SRS transmission and initializes with various parameters like 1. UE specific ID for SRS, 2. n_SRS\hat{ }CS in an RRC parameter called transmissioncomb, 3. cyclicshifthopping parameter that says if cyclic shift hopping feature is enabled or not, 4. a value S_cs in a parameter called hopping subset, 5. (subsetCS) S_cs that indicated allowed CS values or CS offset values of a subset. The subset is a subset of

$${n}_{csh}^{SRS}$$

values 6.hoppingrinergranularity that says if finergranularity is enabled or not 7. a parameter that says pseudo random generator (PSRG) is reinitialized every N frames or N slots. 8. a parameter that configures the Zadoff Chu sequence to be used 9. other parameters that help UE determine the region of subcarriers to transmit the SRS. At S1704, the UE determines that if cyclicshifthopping is enabled and hoppingfinergranularity is disabled.

At S1706, the UE initializes the PSRG with the value that is a function of the UE specific ID. The pseudo random generator resets itself once every N slots or N frames. 2 The PSRG is run to generate many values. The UE uses the slot number, the frame number, the SFN, the subcarrier spacing, the OFDM symbol number, the number of symbols per slot, and the srs symbol number in the slot for every OFDM symbol to compute a unique number B. Using the unique number, the UE computes the value of A binary bits from (B−1)A to BA of the PSRG output. The UE generates N_ap CS values n_SRS\hat{ }CS, I (I varies from 0 to N_ap−1) that are equidistant (under modulo of n_SRS\hat{ }CS,max) over 0 to n_SRS\hat{ }CS,max and starting from n_SRS\hat{ }CS. The UE takes modulo of the computed value where modulo is with respect to

$${N}_{ch}^{ncsh} SRS .$$

This will give a value (varies with srs OFDM symbol number) between 0 and n_{csh}^{SRS}−1, called as index value. This will be used to pick a value from subsetCS and the UEwill add it to n_SRS\hat{ }CS, I which is the cyclic shift (CS) of i^{th} port in this OFDM symbol. At S1708, the UE uses the CS value to generate a complex exponential sequence and uses the Zadoff chu and complex exponential sequence transmit the SRS over subcarrier regions in the given OFDM symbol.

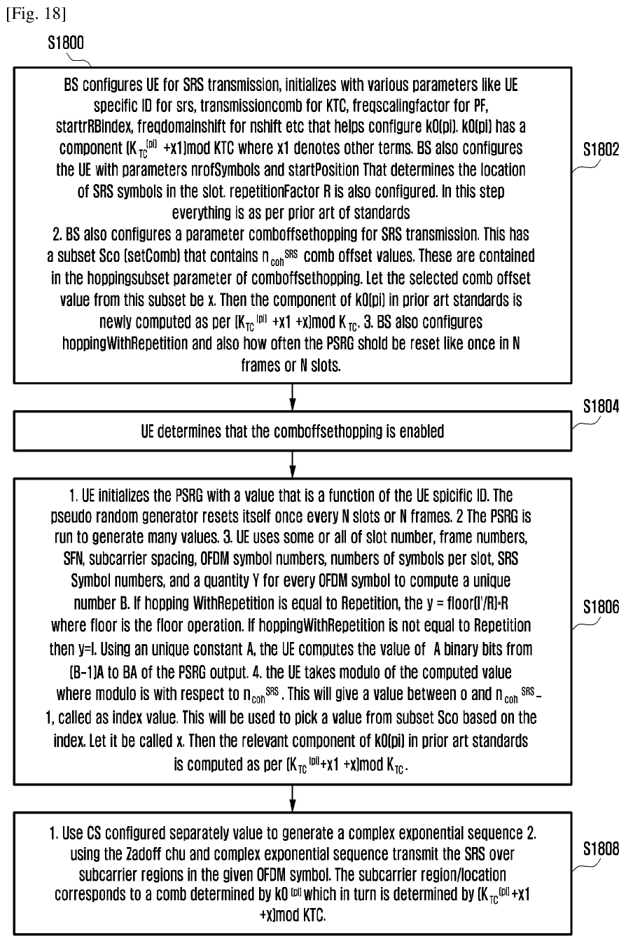

FIG. 18 is a flow chart (S1800) illustrating a comb hopping, according to embodiments as disclosed herein.

At S1802, the BS configures the UE for SRS transmission and initializes with various parameters like UE specific ID for SRS, transmissioncomb for KTC, freqscalingfactor for PF, startrRBindex, freqdomainshift for nshift etc. that helps configure k0(pi). k0(pi) has a component

$$( {K}_{TC}^{( pi )} + x 1 )$$

mod KTC, where X1 denotes other terms. The BS also configures the UE with parameters nrofSymbols and startPosition That determines the location of SRS symbols in the slot. repetitionFactor R is also configured. The BS also configures a parameter comboffsethopping for SRS transmission. This has a subset Sco (setComb) that contains

$${n}_{coh}^{SRS}$$

comb offset values. These are contained in the hoppingsubset parameter of comboffsethopping. Let the selected comb offset value from this subset be x. Then the component of k0(pi) is newly computed as per

$$( {K}_{T C}^{( p i )} + x 1 + x )$$

mod K_{TC}. Further, the BS also configures hoppingWithRepetition and also how often the PSRG should be reset like once in N frames or N slots. At S1804, the UE determines that the comboffsethopping is enabled.

At S1806, the UE initializes the PSRG with the value that is a function of the UE specific ID. The pseudo random generator resets itself once every N slots or N frames. The PSRG is run to generate many values. The UE uses some or all of slot numbers, the frame numbers, the SFN, the subcarrier spacing, the OFDM symbol numbers, the numbers of symbols per slot, the SRS Symbol numbers, and the quantity Y for every OFDM symbol to compute a unique number B. If hopping WithRepetition is equal to Repetition, the y=floor(1′/R)*R where floor is the floor operation. If hopping WithRepetition is not equal to Repetition then y=1. Using a unique constant A, the UE computes the value of A binary bits from (B−1)A to BA of the PSRG output. 4. the UE takes modulo of the computed value where modulo is with respect

$${n}_{c o h}^{SRS} .$$

This will give a value between 0 and

$$( {K}_{T C}^{( p i )} + x 1 + x$$

called as index value. This will be used to pick a value from subset Sco (based on the index. Let it be called x. Then the relevant component of k0(pi) is computed as per

$${n}_{coh}^{SRS} - 1$$

### mod K_{TC}.

At S1808, the UE uses the CS configured separately value to generate a complex exponential sequence, Further, the UE uses the Zadoff chu and complex exponential sequence transmit the SRS over subcarrier regions in the given OFDM symbol. The subcarrier region/location corresponds to a comb determined by k0^{(pi)} which in turn is determined by

$$( {K}_{T C}^{( p i )} + x 1 + x )$$

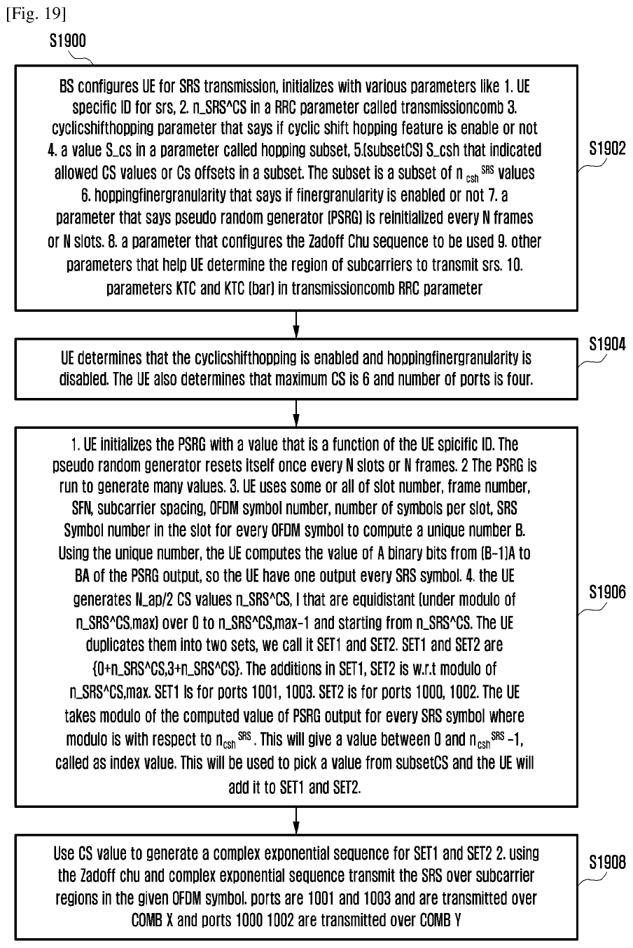

FIG. 19 is a flow chart (S1900) illustrating a CS hopping for Frac CS, according to embodiments as disclosed herein.

At S1902, the BS configures the UE for the SRS transmission and initializes with various parameters like 1. UE specific ID for SRS, 2. n_SRS\hat{ }CS in a RRc parameter called transmissioncomb, 3. cyclicshifthopping parameter that says if cyclic shift hopping feature is enabled or not, 4. a value S_cs in a parameter called hopping subset, 5. (subsetCS) S_cs that indicated allowed CS values or CS offsets of a subset. The subset is a subset of

$${n}_{c s h}^{S R S} - 1 ,$$

values, 6. hoppingfinergranularity that says if finergranularity is enabled or not, 7. a parameter that says pseudo random generator (PSRG) is reinitialized every N frames or N slots. 8. a parameter that configures the Zadoff Chu sequence to be used 9. other parameters that help UE determine the region of subcarriers to transmit srs. 10. parameters KTC and KTC (bar) in transmissioncomb RRC parameter.

At S1904, the UE determines that the cyclicshifthopping is enabled and hoppingfinergranularity is disabled. The UE also determines that maximum CS is 6 and number of ports is four.

At S1906, the UE initializes the PSRG with a value that is a function of the UE specific ID. The pseudo random generator resets itself once every N slots or N frames. The PSRG is run to generate many values. The UE uses some or all of slot number, the frame number, the SFN, the subcarrier spacing, the OFDM symbol number, the number of symbols per slot, the SRS symbol number in the slot for every OFDM symbol to compute a unique number B. Using the unique number, the UE computes the value of A binary bits from (B−1)A to BA of the PSRG output, so the UE have one output for every SRS symbol. The UE generates N_ap/2 CS values n_SRS\hat{ }CS, I that are equidistant (under modulo of n_SRS\hat{ }CS,max) over 0 to n_SRS\hat{ }CS,max−1 and starting from n_SRS\hat{ }CS. The UE duplicates them into two sets, we call it SET1 and SET2. SET1 and SET2 are {0+n_SRS\hat{ }CS,3+n_SRS\hat{ }CS}. The additions in SET1, SET2 is with respect to the modulo of n_SRS\hat{ }CS,max. SET1 μs for ports 1001, 1003. SET2 is for ports 1000,1002. The UE takes modulo of the computed value of PSRG output for every SRS symbol where modulo is with respect to

$${n}_{c s h}^{S R S} .$$

This will five a value between 0 and

$${n}_{csh}^{SRS}$$

called as index value. This will be used to pick a value from subsetCS and the UE will add it to SET1 and SET2.

At S1908, the UE uses the CS value to generate a complex exponential sequence for SET1 and SET2 and the UE uses the Zadoff chu and complex exponential sequence transmit the SRS over subcarrier regions in the given OFDM symbol. ports are 1001 and 1003 and are transmitted over COMB X and ports 1000 1002 are transmitted over COMB Y.

The frequency-domain starting position (of a comb)

$${k}_{o}^{( {p}_{i} )}$$

is defined by (as per existing standards)

$${k}_{0}^{( {p}_{i} )} = {\overline{k}}_{0}^{( {p}_{i} )} + {n}_{offset}^{F H} + {n}_{offset}^{R P F S}$$

$$where$$

$${\overline{k}}_{0}^{( {p}_{i} )} = {n}_{s hift} {N}_{s c}^{R B} + ( {k}_{T C}^{( {p}_{i} )} + {k}_{offset}^{{l}^{′}} ) mod {K}_{T C}$$

$${k}_{T C}^{( {p}_{i} )} = ( \begin{matrix}( {\overline{k}}_{TC} + {K}_{TC} / 2 ) mod {K}_{TC} & COND 1 is true \\ {k}_{TC} & otherwise\end{matrix}$$

$${n}_{offset}^{F H} = {\sum }_{b = 0}^{{B}_{S R S}} {K}_{T C} {M}_{sc , b}^{S R S} {n}_{b}$$

$${n}_{offset}^{R P F S} = {N}_{s c}^{R B} {m}_{S R S , {B}_{S R S}} ( ( {k}_{F} + {k}_{h o p} ) mod {P}_{F} ) / {P}_{F}$$

Note that SET1 corresponds to COMB X. This is when COND1 is true and SET2 corresponds COMB Y. COND1 is not TRUE.

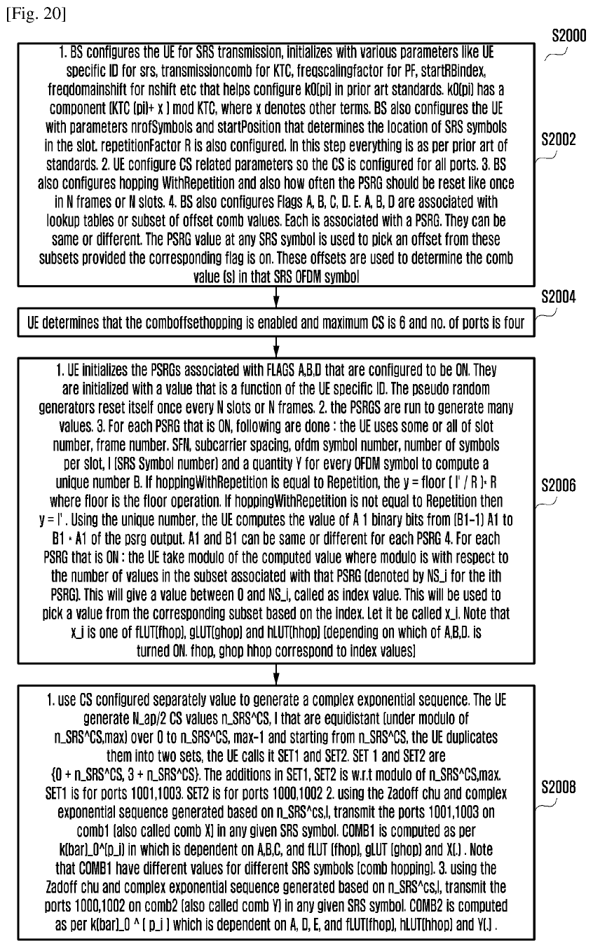

FIG. 20 is a flow chart (S2000) illustrating a comb hopping for Frac CS, according to embodiments as disclosed herein.

At S2002, the BS configures the UE for SRS transmission and initializes with various parameters like UE specific ID for srs, transmissioncomb for KTC, freqscalingfactor for PF, startrRBindex, freqdomainshift for nshift etc. that helps configure k0(pi). k0(pi) has a component (KTC(pi)+x) mod KTC, where x denotes other terms. Further, the BS also configures the UE with parameters nrofSymbols and startPosition that determines the location of SRS symbols in the slot. repetitionFactor R is also configured. The configure CS related parameters so the CS is configured for all ports. Further, the BS also configures hopping WithRepetition and also how often the PSRG should be reset like once in N frames or N slots. Further, the BS also configures Flags A, B, C, D, E. A, B, D that are associated with lookup tables or subset of offset comb values. Each is associated with a PSRG. They can be the same or different. The PSRG value at any SRS symbol is used to pick an offset from these subsets provided the corresponding flag is ON. These offsets are used to determine the comb value(s) in that SRS OFDM symbol.

At S2004, the UE determines that the comboffsethopping is enabled, and maximum CS is 6 and no. of ports is four.

At S2006, the UE initializes the PSRGs associated with FLAGS A, B, and D that are configured to be ON. They are initialized with a value that is a function of the UE specific ID. The pseudo random generators reset itself once every N slots or N frames. Further, the PSRGS are run to generate many values. For each PSRG that is ON, the following are done: the UE uses some or all of slot number, frame number. SFN, subcarrier spacing, OFDM symbol number, number of symbols per slot, 1 (SRS Symbol number) and a quantity Y for every OFDM symbol to compute a unique number B. If hopping WithRepetition is equal to Repetition, the y=floor (1′/R)*R where floor is the floor operation. If hopping WithRepetition is not equal to Repetition then y=l′. Using the unique number, the UE computes the value of A1 binary bits from (B1−1)A1 to B1*A1 of the psrg output. A1 and B1 can be same or different for each PSRG 4. For each PSRG that is ON: the UE take modulo of the computed value where modulo is with respect to the number of values in the subset associated with that PSRG (denoted by NS_i for the ith PSRG). This will give a value between 0 and NS_i, called as index value. This will be used to pick a value from the corresponding subset based on the index. Let it be called x_i. Note that x_i is one of fLUT(fhop), gLUT(ghop) and hLUT(hhop) (depending on which of A,B,D. is turned ON.fhop, ghop hhop correspond to index values.

At S2008, the UE uses the CS configured separately value to generate a complex exponential sequence. The UE generate N_ap/2 CS values n_SRS\hat{ }CS, I that are equidistant (under modulo of n_SRS\hat{ }CS,max) over 0 to n_SRS\hat{ }CS,max and starting from n_SRS\hat{ }CS, the UE duplicates them into two sets, the UE calls it SET1 and SET2. SET1 and SET2 are {0+n_SRS\hat{ }CS,3+n_SRS\hat{ }CS}. The additions in SET1, SET2 is w.r.t modulo of n_SRS\hat{ }CS,max. SET1 is for ports 1001,1003. SET2 is for ports 1000,1002. Further, the UE uses the Zadoff chu and complex exponential sequence generated based on n_SRS\hat{ }cs,I, transmit the ports 1001,1003 on comb1 in any given SRS symbol. COMB1 (as called comb1) is computed as per k (bar)_0\hat{ }(p_i) in th which is dependent on A,B,C, and fLUT(fhop), gLUT(ghop) and X(·). Note that COMB1 have different values for different SRS symbols (comb hopping). 3. using the Zadoff chu and complex exponential sequence generated based on n_SRS\hat{ }cs,I, transmit the ports 1000,1002 on comb2 in any given SRS symbol. COMB2 (also called comb Y) is computed as per k (bar)_0\hat{ }(p_i) which is dependent on A, D, E, and fLUT(fhop), hLUT(hhop) and Y(·).

The frequency-domain starting position

$${k}_{o}^{( {p}_{i} )}$$

is defined by:

$${k}_{0}^{( {p}_{i} )} = {\overline{k}}_{0}^{( {p}_{i} )} + {n}_{offset}^{F H} + {n}_{offset}^{R P F S}$$

$$Where {\overline{k}}_{0}^{( {p}_{i} )} = {n}_{shift} {N}_{s c}^{R B} + ( {k}_{T C}^{( {p}_{i} )} + {k}_{offset}^{{l}^{′}} + A {f}_{L U T} ( {f}_{h o p} ) ) mod {K}_{T C}$$

$${k}_{TC}^{( {p}_{i} )} = \{ \begin{matrix}( {\overline{k}}_{TC} + {K}_{TC} / 2 + {Bg}_{LUT} ( {g}_{hop} ) + CX ( . ) ) mod {K}_{TC} & if COND 1 is TRUE \\ ( {\overline{k}}_{TC} + {Dh}_{LUT} ( {h}_{hop} ) + ET ( . ) ) mod {K}_{TC} & if COND 2 is true \\ ( {\overline{k}}_{TC} ) & otherwise\end{matrix}$$

$${n}_{offset}^{F H} = {\sum }_{b = 0}^{{B}_{S R S}} {K}_{T C} {M}_{sc , b}^{S R S} {n}_{b}$$

$${n}_{offset}^{R P F S} = {N}_{sc}^{R B} {m}_{S R S , {B}_{S R S}} ( ( {k}_{F} + {k}_{h o p} ) mod {P}_{F} ) / {P}_{F}$$

K_{F}∈{0, 1, . . . , P_{F}−1} is given by the higher-layer parameter StartRBIndex if configured, otherwise k_{F}=0;

Where the new hopping additions are in RED fonts. A,B,C,D,E are all Flags to turn ON or OFF a corresponding feature and take values 0 or 1 to give different embodiments, f_{LUT} is a lookup table of f hopping values. fₕₒₚ takes a value (between 1 and f) based on OFDM symbol number, system frame number, slot number and any other UE/SRS ID like RNTI etc.

Similarly, g_{LUT} is a lookup table of g hopping values. gₕₒₚ takes a value (between 1 and g) based on OFDM symbol number, system frame number, slot number and any other UE/SRS ID like RNTI etc. h_{LUT} is a lookup table of h hopping values. hhop takes a value (between 1 and h) based on OFDM symbol number, system frame number, slot number and any other UE/SRS ID like RNTI etc.

Furthermore, the user of the UE defines α₁=Bg_{LUT}(gₕₒₚ) and α₂=Dh_{LUT}(hₕₒₚ). X(·) and Y(·) are functions providing offset values, X(·) is a function or look-up table can take one of α₂, symbol number, slot number, frame number, any UE identity like cell ID

$${n}_{ID}^{cell} ,$$

SRS sequence identity

$${n}_{I D}^{S R S} , C - RNTI ,$$

or a new ID. Similarly, Y(·) is a function or look-up table can take one of α₁, symbol number, slot number, frame number, any UE identity like cell ID

$${n}_{I D}^{cell} , SRS$$

sequence identity

$${n}_{I D}^{S R S} , C - RNTI ,$$

or a new ID. Note that with the proposed method

$${k}_{TC}^{( {p}_{i} )}$$

has different values OFDM symbols and this is achieved by having

$${\overline{k}}_{T C}$$

as constant g_{LUT}(gₕₒₚ), or h_{LUT}(hₕₒₚ) or Af_{LUT}(fₕₒₚ) which changes values across OFDM symbols. This is equivalent to not having g_{LUT}(gₕₒₚ) or h_{LUT}(hₕₒₚ) or Af_{LUT}(fₕₒₚ) and instead have a

$${\overline{k}}_{TC}$$

that changes across OFDM symbols.

Normally, all N_ap ports of a UE are assigned distinct (cyclic shifts) CSs in one particular comb. In this case, N_ap, the number of ports perfectly divides the maximum cyclic shift value and over this range of maximum cyclic shift value, the UE (2100) have N_ap CSs evenly distributed or equi-distant. For example, if maximum CS value=12 and there are four ports, the CS values of these ports can be 0, 3, 6, and 9.

For the case when maximum CS=6 and there are four ports, it is not possible to accommodate four CS values to these ports evenly over the range 0-5. So, in such cases, the UE (2100) accommodates two ports on one comb (with two CS values) and two other ports (with similar two CS values) in another comb. Now, for CS hopping, in any given SRS symbol, the two combs accommodating these four ports is constant and within these combs, the CS values vary (hop) as the SRS OFDM symbol changes (the CS values of two ports in each comb is the same). In comb hopping, the combs change every SRS symbol (the distance between combs remain the same). However, the CS values assigned to the ports in the two combs do not change.

As an example: if there are four SRS OFDM symbol. If n_srs\hat{ }{CS,max} (maximum CS) is equal to 6, number of combs is 8. For CS hopping
1. SRS symbol 1: CSs 0,3 in comb=0 and CS 0,3 in Comb=4.
2. SRS symbol 2: CSs 1,4 in comb=0 and CS 1,4 in Comb=4.
3. SRS symbol 3: CSs 2,5 in comb-0 and CS 2,5 in Comb=4.
4. SRS symbol 4: CSs 3,0 in comb-0 and CS 3,0 in Comb=4.

Note that comb values are constant. Hopping CS values across SRS symbols are in

### Bold

For comb hopping
1. SRS symbol 1: CSs 0,3 in comb=0 and CS 0,3 in Comb=4.
2. SRS symbol 1: CSs 0,3 in comb=1 and CS 0,3 in Comb=5.
3. SRS symbol 1: CSs 0,3 in comb=2 and CS 0,3 in Comb=6.
4. SRS symbol 1: CSs 0,3 in comb=3 and CS 0,3 in Comb=7.

Note that CS values are constant while comb values hop (CHANGE) AND ARE IN bold.

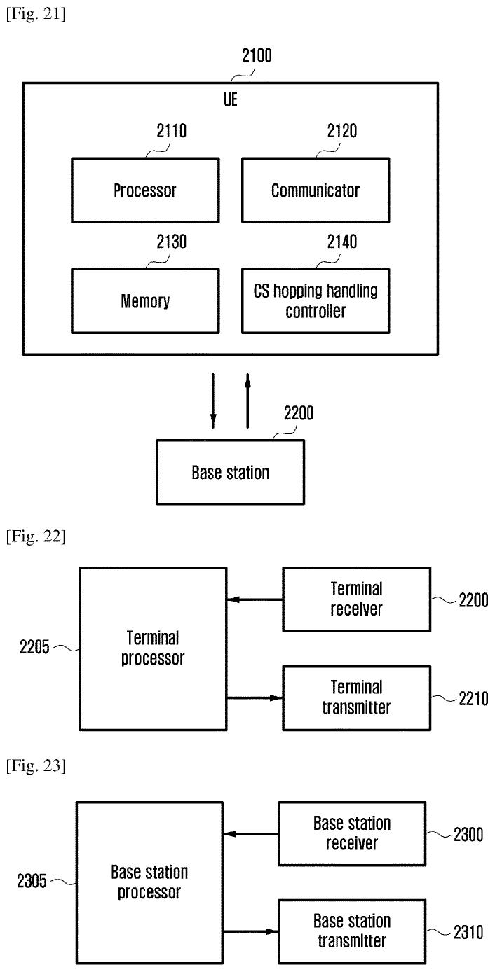

FIG. 21 shows various hardware components of the UE (2100) included in a wireless network (2300), according to the embodiments as disclosed herein. The wireless network (2300) includes the UE (2100) and the base station (2200).

In an embodiment, the UE (2100) includes a processor (2110), a communicator (2120), a memory (2130) and a CS hopping handling controller (2140). The processor (2110) is coupled with the communicator (2120), the memory (2130) and the CS hopping handling controller (2140).

The CS hopping handling controller (2140) determines that the cyclic shift hopping is enabled and the hopping finer granularity is disabled upon determining that the base station (2200) configures the UE (2100) for SRS transmission using at least one parameter. In an embodiment, the at least one parameter includes at least one of: the UE specific ID for SRS, the transmissioncomb, the cyclicshifthopping parameter that indicate if cyclic shift hopping feature is enabled or not, the hopping subset, the subsetCS that indicate allowed CS values of the subset, the pseudo random generator (PSRG) reinitialized every N frames or N slots, the parameter configuring the Zadoff Chu sequence to be used, and the parameter helping the UE (2100) to determine the region of subcarriers to transmit the SRS.

In an embodiment, the at least one parameter comprises at least one of: the UE specific ID for SRS, the transmissioncomb, the cyclicshifthopping parameter that indicate if cyclic shift hopping feature is enabled or not, the hopping subset, the subsetCS of CS offset values that indicate allowed CS offset values of the subset, where the Cs offset values from the subset will be added to existing CS values to determine the final CS values, the pseudo random generator (PSRG) reinitialized every N frames or N slots, a parameter configuring a Zadoff Chu sequence to be used, and a parameter helping the UE to determine a region of subcarriers to transmit the SRS.

Further, the CS hopping handling controller (2140) performs at least one of: initializing the PSRG with a value that is a function of a UE specific identifier (ID), using a pseudo random generator resets itself once every N slots or N frames, using the PSRG run to generate a value, using one or more of the slot number, the frame number SFN, the subcarrier spacing, the OFDM symbol number in the slot, the number of symbols per slot, srs symbol number in the slot for every SRS OFDM symbol to compute an unique number and generating a CS values corresponding to that SRS OFDM symbol using the unique number. Further, the CS hopping handling controller (2140) performs at least one of: uses the CS value to generate a complex exponential sequence and uses a Zadoff chu and complex exponential sequence transmit the SRS over a subcarrier region in an OFDM symbol.

In an embodiment, using the unique number, the UE (2100) selects a CS offset value from the hopping subset subsetCS, wherein the UE (2100) calculates as many CSs as there are ports of the UE (2100), wherein the CS value of a port of UE has two parts; wherein the first part is calculated such that the first part of CS values for all ports are equidistant over the range of allowable CS values, which is zero to maximum CS value minus one, wherein the exact CS values of the first part of a port is determined by higher layers configuration, wherein the UE adds a second part of CS value to the first part of CS values of all ports, wherein the addition of the first part and second part is under modulo of maximum CS value, wherein the second part of the CS value is the selected CS offset values from hopping subset or subsetCS, wherein the CS value of each port determines the complex exponential sequence, wherein the complex exponential sequence along with the determined Zadoff-Chu sequence is used to transmit the SRS of the port of the UE over the determined/configured region of subcarriers.

In another embodiment, the CS hopping handling controller (2140) determines that the comb offset hopping is enabled upon determining the base station (2200) configures the UE (2100) for SRS transmission using the at least one parameter. Further, the CS hopping handling controller (2140) is configured to perform at least one of: initializing a PSRG with a value that is a function of a UE specific identifier (ID), using a pseudo random generator resets itself once every N slots or N frames, using the PSRG run to generate a value, using the slot number, the frame number SFN, the subcarrier spacing, the OFDM symbol number, the number of symbols per slot, the SRS symbol number in the slot for every OFDM symbol, a quantity that is dependent on higher layer parameter hoppingWithRepetition, higher layer parameter repetitionFactor, and the OFDM symbol number in a slot to compute the unique number, wherein the unique number will be used to determine the comb used in that SRS OFDM symbol and generating a CS value. Further, the CS hopping handling controller (2140) is configured to perform at least one of: using a CS configured separately to generate a complex exponential sequence and using a Zadoff chu and complex exponential sequence transmit the SRS over subcarrier regions in an OFDM symbol.

In an embodiment, the at least one parameter comprises at least one of: a UE specific ID for SRS, a transmissioncomb for KTC, a freqscalingfactor for PF, a startrRBindex, and a freqdomainshift. In an embodiment, the base station (2200) configures the UE (2100) with a parameter comprising a nrofSymbols and a startPosition that determines a location of SRS symbols in the slot, wherein the base station configures a repetitionFactor. In an embodiment, the base station (2200) configures a parameter comprising a comboffsethopping for SRS transmission, wherein the comboffsethopping has a subset setCSComb that contains comb offset values. In an embodiment, the base station (2200) configures a hopping WithRepetition.

In an embodiment, the CS hopping handling controller (2140) determines that the cyclic shift hopping is enabled and the hopping finer granularity is disabled upon determining that the base station (2200) configures the UE (2100) for the SRS transmission using at least one parameter. In an embodiment, the at least one parameter includes at least one of: the UE specific ID for the SRS, the transmissioncomb, the cyclicshifthopping parameter that indicate if the cyclic shift hopping feature is enabled or not, the hopping subset, the subsetCS that indicate allowed CS values of a subset, the PSRG reinitialized every N frames or N slots, the parameter configuring the Zadoff Chu sequence to be used, and the parameter helping the UE to determine the region of subcarriers to transmit the SRS. In another embodiment, the at least one parameter includes at least one of: the UE specific ID for the SRS, the transmissioncomb, the cyclicshifthopping parameter that indicate if the cyclic shift hopping feature is enabled or not, the hopping subset, the subsetCS of CS offset values that indicate allowed CS offset values of the subset, where the CS offset values from the subset will be added to existing CS values to determine the final CS values, the PSRG reinitialized every N frames or N slots, the parameter configuring the Zadoff Chu sequence to be used, and the parameter helping the UE to determine the region of subcarriers to transmit the SRS.

Further, the CS hopping handling controller (2140) determines that a number of ports of the UE (2100) is four and maximum cyclic shift is six. Further, the CS hopping handling controller (2140) performs at least one of: initializes the PSRG with the value that is a function of the UE specific identifier (ID), use the PSRG that resets itself once every N slots or N frames, uses the PSRG run to generate the value using one or more of the slot number, the frame number, the SFN, the subcarrier spacing, the OFDM symbol number in the slot, the number of symbols per slot, the number of slots per frame, and the SRS symbol number in the slot for every SRS OFDM symbol to compute the unique number and generating two sets of identical two CS values corresponding to the SRS OFDM symbol using the unique number. Further, the CS hopping handling controller (2140) performs at least one of: uses the CS value to generate the complex exponential sequence and uses the Zadoff chu and complex exponential sequence transmit the SRS over a subcarrier region in an OFDM symbol.

In an embodiment, using the unique number, the UE (2100) selects the CS offset value from the hopping subset subsetCS, wherein the UE (2100) computes two identical sets of two CSs each, wherein a first set corresponds to ports 1001 and 1003 and a second set corresponds to ports 1000 and 1002, wherein the first set is transmitted in Comb X and the second set is transmitted in Comb Y, wherein the CS value of a port in any of the two identical sets of UE has two parts, wherein a first part is computed such that the first part of CS values for the two ports are equidistant over a range of allowable CS values, which is zero to maximum CS value minus one, wherein the exact CS values of the first part of the port is determined by higher layers configuration; wherein the UE (2100) adds a second part of CS value to the first part of CS values of all ports, wherein the addition of the first part and second part is under modulo of maximum CS value, wherein the second part of the CS value is the selected CS offset values from hopping subset or subsetCS using the unique derived from the PSRG output for the SRS OFDM symbol, wherein the CS value of each port determines the complex exponential sequence, and wherein the complex exponential sequence along with the determined Zadoff-Chu sequence is used to transmit the SRS of the port of the UE over the determined region of subcarriers, wherein the configured region of subcarriers determines the comb X and the comb Y, wherein for combX the seventh quantity is the sum of transmissioncomboffset and half of KTC (transmissioncombnumber), wherein the sum is modulo transmissioncombnumber; wherein the ninth quantity is zero; wherein the starting position of the comb is in a frequency domain, wherein for the comb Y, the seventh quantity is just the transmissioncomboffset, wherein the ninth quantity is zero, and wherein the starting position of the comb is in the frequency domain.

In another embodiment, the CS hopping handling controller (2140) determines that the comb offset hopping is enabled upon determining the base station (2200) configures the UE (2100) for SRS transmission using at least one parameter. The at least one parameter includes at least one of: a UE specific ID for SRS, a transmissioncomb for KTC (transmissioncombnumber), a transmissioncomb for transmissioncomboffset, a freqscalingfactor for PF, a startrRBindex, and a freqdomainshift.

Further, the CS hopping handling controller (2140) determines that the number of ports of the UE (2100) is four and the maximum CS value is six. Further, the CS hopping handling controller (2140) performs at least one of: initializes the PSRG with the value that is a function of the UE specific ID, uses the pseudo random generator resets itself once every N slots or N frames, uses the PSRG run to generate the value, uses one or more of the slot number, the frame number, the SFN, the subcarrier spacing, the OFDM symbol number in the slot, the number of symbols per slot, the SRS symbol number in the slot for every OFDM symbol, the quantity that is dependent on the higher layer parameter hoppingWithRepetition, the higher layer parameter repetitionFactor, and the OFDM symbol number in the slot to compute the unique number, wherein the unique number is used to determine a comb offset value associated with two combs, wherein the first comb is comb X and a second comb is comb Y, wherein the comb X is associated with ports 1001 and 1003, wherein a comb Y is associated with ports 1000 and 10012, wherein comb X and comb Y are used in that SRS OFDM symbol and changes with SRS OFDM symbol if hopping WithRepetition is not set to repetition, wherein comb x and comb Y will change across a set of every repetitionFactor number of SRS OFDM symbols and will be constant within the set of repetitionFactor number of SRS OFDM symbols if hopping WithRepetition is set to repetition, wherein the CS values used for the comb X and ports 1001 and 1003 are two CS values distributed evenly over allowable CS values 0 to max cyclic shift value minus unity, and one of the CS values is configured with the help of a parameter that is configured by higher values; wherein the CS values used for comb Y and ports 1000 and 1002 are the same set of CS values used for Comb X.

Further, the CS hopping handling controller (2140) performs at least one of: uses the CS configured separately to generate the complex exponential sequence and uses a Zadoff chu and complex exponential sequence transmit the SRS over subcarrier regions in the OFDM symbol.

The base station (2200) configures the UE (2100) with the parameter comprising the nrofSymbols and a startPosition that determines a location of SRS symbols in the slot, wherein the base station (2200) configures a repetitionFactor. In another embodiment, the base station (2200) configures a parameter comprising a comboffsethopping for SRS transmission, wherein the comboffsethopping has a subset setComb that contains comb offset values. In another embodiment, the base station (2200) configures a hopping WithRepetition.

In another embodiment, in the starting position in frequency domain of the combX of SRS is a sum of four quantities, wherein the first quantity is a sum of fifth, and sixth quantity, where in sixth quantity is a sum of seventh, eight quantity and ninth quantity, wherein sum of seventh, eighth and ninth quantity is modulo KTC, wherein the ninth quantity uses the unique number to pick a comb offset value from the subset setComb; wherein the starting position of the comb changes every SRS OFDM symbol; wherein for combX the seventh quantity is the sum of transmissioncomboffset and half of KTC (transmissioncombnumber), wherein the sum is modulo transmissioncombnumber;

In another embodiment, in the starting position in frequency domain of the combY of SRS is a sum of four quantities, wherein the first quantity is a sum of fifth, and sixth quantity, where in sixth quantity is a sum of seventh, eight quantity and ninth quantity, wherein sum of seventh, eighth and ninth quantity is modulo KTC, wherein the ninth quantity uses the unique number to pick a comb offset value from the subset setComb; wherein the starting position of the comb changes every SRS OFDM symbol, wherein for combY the seventh quantity is the transmissioncomboffset

In another embodiment, the quantity is the SRS symbol number if hoppingwithrepetition is not configured, wherein the quantity is derived from the repition factor, and a floor of the ratio of SRS symbol number and the repetition factor.

Finally, SetCS, subsetCS, S_{CS}, all could mean different embodiments/manifestation of same/similar thing. Likewise, setcomb, Sco, could mean different embodiments/manifestation of same/similar thing.

The CS hopping handling controller (2140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (2110) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (2110) may include multiple cores and is configured to execute the instructions stored in the memory (2130).

Further, the processor (2110) is configured to execute instructions stored in the memory (2130) and to perform various processes. The communicator (2120, or a transceiver) is configured for communicating internally between internal hardware components and with external devices via one or more networks. The memory (2130) also stores instructions to be executed by the processor (2110). The memory (2130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (2130) may, in some examples, be considered a non-transitory storage medium. The term “non-transitory” may indicate that the storage medium is not embodied in a carrier wave or a propagated signal. However, the term “non-transitory” should not be interpreted that the memory (2130) is non-movable. In certain examples, a non-transitory storage medium may store data that can, over time, change (e.g., in Random Access Memory (RAM) or cache).

Although FIG. 21 shows various hardware components of the UE (2100) but it is to be understood that other embodiments are not limited thereon. In other embodiments, the UE (2100) may include less or more number of components. Further, the labels or names of the components are used only for illustrative purposes and does not limit the scope of the invention. One or more components can be combined together to perform the same or substantially similar function in the UE (2100).

FIG. 22 illustrates a structure of a terminal in a wireless communication system according to an embodiment of the present disclosure.

Referring to FIG. 22, the terminal may include a transceiver indicating a terminal receiver 2200 and a terminal transmitter 2210, a memory (not shown), and a terminal processor 2205 (or a terminal controller or processor). The transceiver 2200 and 2210, the memory, and the terminal processor 2205 of the terminal may operate according to the above-described terminal communication method. However, the components of the terminal are not limited to the examples described above. For example, the terminal may include more or fewer components than the above-described components. In addition, the transceiver, the memory, and the processor may be implemented in the form of a single chip.

The transceiver may transmit or receive a signal to or from a base station. Here, the signal may include control information and data. To this end, the transceiver may include an RF transmitter configured to up-convert and amplify the frequency of the transmitted signal, an RF receiver configured to amplify the received signal with low noise and down-convert the frequency, and the like. However, this is only an embodiment of the transceiver, and the components of the transceiver are not limited to the RF transmitter and the RF receiver.

In addition, the transceiver may receive a signal through a wireless channel, output the signal to the processor, and transmit a signal output from the processor through the wireless channel.

The memory may store programs and data necessary for the operation of the terminal. In addition, the memory may store control information or data included in signals transmitted and received by the terminal. The memory may include a storage medium such as a ROM, a RAM, a hard disk, a CD-ROM, and a DVD, or a combination of storage media. In addition, there may be multiple memories.

In addition, the processor may control a series of processes so that the terminal operates according to the embodiments described above. For example, the processor may control a component of the terminal to simultaneously receive multiple PDSCHs by receiving DCI including two layers. There may be multiple processors, and the processor may perform an operation of controlling components of the terminal by executing a program stored in the memory.

FIG. 23 illustrates a structure of a base station in a wireless communication system according to an embodiment of the present disclosure.

Referring to FIG. 23, the base station may include a transceiver indicating a base station receiver 2300 and a base station transmitter 2310, a memory (not shown), and a base station processor 2305 (or a base station controller or processor). The transceiver 2300 and 2310, the memory, and the base station processor 2305 of the base station may operate according to the above-described base station communication method. However, the components of the base station are not limited to the examples described above. For example, the base station may include more or fewer components than the above-described components. In addition, the transceiver, the memory, and the processor may be implemented in the form of a single chip.

The transceiver may transmit or receive a signal to or from a terminal. Here, the signal may include control information and data. To this end, the transceiver may include an RF transmitter configured to up-convert and amplify the frequency of the transmitted signal, an RF receiver configured to amplify the received signal with low noise and down-convert the frequency, and the like. However, this is only an embodiment of the transceiver, and the components of the transceiver are not limited to the RF transmitter and the RF receiver.

In addition, the transceiver may receive a signal through a wireless channel, output the signal to the processor, and transmit a signal output from the processor through the wireless channel.

The memory may store programs and data necessary for the operation of the base station. In addition, the memory may store control information or data included in signals transmitted and received by the base station. The memory may include a storage medium such as a ROM, a RAM, a hard disk, a CD-ROM, and a DVD, or a combination of storage media. In addition, there may be multiple memories.

The processor may control a series of processes so that the base station operates according to an embodiment of the disclosure. For example, the processor configure DCI of two layers including allocation information of multiple PDSCHs and control each component of the base station in order to transmit the same. There may be multiple processors, and the processor may perform an operation of controlling components of the base station by executing a program stored in the memory.

The methods according to embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Further, the above respective embodiments may be employed in combination, as necessary. For example, one embodiment of the disclosure may be partially combined with another embodiment to operate a base station and a terminal. As an example, embodiments 1 and 2 of the disclosure may be partially combined to operate a base station and a terminal. Further, although the above embodiments have been described by way of the FDD LTE system, other variants based on the technical idea of the embodiments may be implemented in other systems such as TDD LTE and 5G or NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Further, in methods of the disclosure, some or all of the contents of each embodiment may be implemented in combination without departing from the essential spirit and scope of the disclosure.

1. A method performed by a user equipment (UE) in a wireless communication system, the method comprising:
receiving, from a base station, parameters associated with a sounding reference signal (SRS);
generating cyclic shift hopping values based on a pseudo random generator (PSRG) using a system frame number, a slot number,
an orthogonal frequency division multiplexing (OFDM) symbol number, and a subcarrier spacing;
generating an SRS sequence based on the cyclic shift hopping values; and
transmitting, to the base station, the SRS sequence.

2. The method of claim 1,
wherein the cyclic shift hopping values are included in a set of cyclic shift configured to the UE.

3. The method of claim 5, wherein the
generating comb hopping values based on the PSRG using the system frame number, the slot number, the OFDM symbol number, the subcarrier spacing, and a repetition factor; and
identifying subcarrier regions for transmitting the SRS sequence based on the comb hopping values,
wherein the SRS sequence is transmitted on the subcarrier regions.

4. The method of claim 3,
wherein the comb hopping values are included in a set of combs configured to the UE.

5. A method performed by a base station in a wireless communication system, the method comprising:
transmitting, to a user equipment (UE), parameters associated with a sounding reference signal (SRS); and
receiving, from the UE, an SRS sequence,
wherein the SRS sequence is based on cyclic shift hopping values, and
wherein the cyclic hopping values are based on a pseudo random generator (PSRG) using a system frame number, a slot number,
an orthogonal frequency division multiplexing (OFDM) symbol number, and a subcarrier spacing.

6. The method of claim 5,
wherein the cyclic shift hopping values are included in a set of cyclic shift configured to the UE.

7. The method of claim 5
wherein the SRS sequence is received on subcarrier regions,
wherein the subcarrier regions are based on comb hopping values, and
wherein the comb hopping values are based on the PSRG using the system frame number, the slot number, the OFDM symbol number, the subcarrier spacing, and a repetition factor.

8. The method of claim 7,
wherein the comb hopping values are included in a set of combs configured to the UE.

9. A user equipment (UE) in a wireless communication system, the UE comprising:
a communicator; and
a processor configured to:
receive, from a base station, parameters associated with a sounding reference signal (SRS),
generate cyclic shift hopping values based on a pseudo random generator (PSRG) using a system frame number, a slot number,
an orthogonal frequency division multiplexing (OFDM) symbol number, and a subcarrier spacing,
generate an SRS sequence based on the cyclic shift hopping values, and
transmit, to the base station, the SRS sequence.

10. The UE of claim 9,
wherein the cyclic shift hopping values are included in a set of cyclic shift configured to the UE.

11. The UE of claim 9, wherein the processor is configured to:
generate comb hopping values based on the PSRG using the system frame number, the slot number, the OFDM symbol number, the subcarrier spacing, and a repetition factor, and
identify subcarrier regions for transmitting the SRS sequence based on the comb hopping values,
wherein the SRS sequence is transmitted on the subcarrier regions.

12. The UE of claim 11,
wherein the comb hopping values are included in a set of combs configured to the UE.

13. A base station in a wireless communication system, the base station comprising:
a communicator;
a processor configured to:
transmit, to a user equipment (UE), parameters associated with a sounding reference signal (SRS), and
receive, from the UE, an SRS sequence,
wherein the SRS sequence is based on cyclic shift hopping values, and
wherein the cyclic hopping values are based on a pseudo random generator (PSRG) using a system frame number, a slot number,
an orthogonal frequency division multiplexing (OFDM) symbol number, and a subcarrier spacing.

14. The base station of claim 13,
wherein the cyclic shift hopping values are included in a set of cyclic shift configured to the UE.

15. The base station of claim 13,
wherein the SRS sequence is received on subcarrier regions,
wherein the subcarrier regions are based on comb hopping values, and
wherein the comb hopping values are based on the PSRG using the system frame number, the slot number, the OFDM symbol number, the subcarrier spacing, and a repetition factor.
